(19) United States
(12) Patent Application Publication
(10) Pub. No.: US 2015/0350906 A1
(43) Pub. Date: Dec. 3, 2015

(54) SYSTEMS AND METHODS FOR SELECTIVE ASSOCIATION

(71) Applicant: QUALCOMM Incorporated, San Diego, CA (US)

(72) Inventors: Abhishek Pramod Patil, San Diego, CA (US); Soo Bum Lee, San Diego, CA (US); George Cherian, San Diego, CA (US); Santosh Paul Abraham, San Diego, CA (US)

(21) Appl. No.: 14/724,553

(22) Filed: May 28, 2015

Related U.S. Application Data
(60) Provisional application No. 62/005,515, filed on May 30, 2014.

(51) Int. Cl. H04W 12/06; H04W 12/04; H04L 9/08; H04W 4/06; H04L 29/06

(52) U.S. Cl. CPC H04W 12/06; H04W 4/06; H04L 63/162; H04L 63/0428; H04L 9/0833; H04W 12/04

(57) ABSTRACT

A particular method includes sending, from a first device to a second device of a data link group, a path request encrypted using a group key of the data link group. The method further includes receiving, at the first device from the second device, a path reply that is responsive to the path request. The method includes selecting the second device for association based on the path reply and associating, by the first device, with the second device.

### I. CLAIM OF PRIORITY

This application claims priority from U.S. Provisional Patent Application No. 62/005,515, filed May 30, 2014, and entitled “SYSTEMS AND METHODS FOR SELECTIVE ROUTE-BASED MESH NETWORK PEERING,” the contents of which are incorporated herein in their entirety.

### II. FIELD

The present disclosure is generally related to selective association.

### III. DESCRIPTION OF RELATED ART

As wireless devices become less expensive and more common, networks can experience increased traffic, potentially burdening the networks, slowing performance of the wireless devices, and frustrating users. Accordingly, network setup and network resource allocation, such as how traffic is routed within the network, may be considered in designing and implementing wireless networks.

Proximity-based services may enable direct communication between devices that are within a particular distance of each other. Proximity-based services may have high overhead corresponding to providing secure communications between the devices. For example, a data link group, such as a social wireless fidelity (Wi-Fi) network, may be built on top of a neighborhood-aware network (NAN). To illustrate, devices of the data link group may be part of the NAN, and one or more devices of the data link group may advertise, via the NAN, availability of a service provided by the data link group. A device may join the data link group to receive data corresponding to the advertised service. For example, a device may join the data link group by associating and authenticating with other devices of the data link group with which the device can directly communicate.

### IV. SUMMARY

In a particular aspect, a method includes sending, from a first device to a second device of a data link group, a path request encrypted using a group key of the data link group. The method further includes receiving, at the first device from the second device, a path reply that is responsive to the path request. The method includes selecting the second device for association based on the path reply and associating, by the first device, with the second device.

In another aspect, a device includes a memory and a processor. The processor is configured to initiate wireless transmission of a path request, encrypted using a group key of a data link group, from a first device to a second device of the data link group and to select the second device for association based on a path reply received from the second device. The path reply is responsive to the path request. The processor is further configured to associate the first device with the second device.

In another aspect, an apparatus includes means for sending, to a device of a data link group, a path request encrypted using a group key of the data link group. The apparatus also includes means for receiving, from the device, a path reply that is responsive to the path request. The apparatus further includes means for selecting the device for association based on the path reply and means for associating with the device.

In another aspect, a computer-readable storage device stores instructions that, when executed by a processor, cause the processor to perform operations including initiating wireless transmission, from a first device to a second device of a data link group, of a path request encrypted using a group key of the data link group. The operations further include selecting the second device for association based on a path reply received from the second device. The path reply is responsive to the path request. The operations also include associating the first device with the second device.

The present disclosure is not limited based on the aspects described in the Summary. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of an illustrative example of a data link group that includes a device configured to selectively associate with another device;

FIG. 2 is a ladder diagram of an illustrative example of messages exchanged between devices of the data link group of FIG. 1;

FIG. 3 is a ladder diagram of an illustrative example of messages exchanged between two devices of the data link group of FIG. 1;

FIG. 4 is a diagram of an illustrative example of propagation of a path request in a data link group;

FIG. 5 is a diagram of an illustrative example of propagation of a path reply in the data link group of FIG. 4;

FIG. 6 is a diagram to illustrate states of a data link group that includes the first device of FIG. 1;

FIG. 7 is a diagram of an illustrative example of a system that includes the data link group of FIG. 1;

FIG. 8 is a diagram of an illustrative example of communication corresponding to a group channel of a data link group, such as the data link group of FIG. 1;

FIG. 9 is a diagram of an illustrative example of a group attribute field that may be included in a discovery message sent by one or more of the devices of FIG. 1;

FIG. 10 is a diagram of an illustrative example of a group control field that may be included in the group attribute field of FIG. 9;

FIG. 11 is a diagram of an illustrative example of a format of a path request that may be sent by one or more devices of FIG. 1;

FIG. 12 is a diagram of an illustrative example of a format of a path reply that may be sent by one or more devices of FIG. 1;

FIG. 13 is a flow chart to illustrate a first method of selective association;

FIG. 14 is a flow chart to illustrate a second method of selective association;

FIG. 15 is a flow chart to illustrate another method of joining a data link group;

FIG. 16 is a flow chart to illustrate another method of operating a device of a data link group;

FIG. 17 is a flow chart to illustrate a method of establishing a pairwise key; and

FIG. 18 is a block diagram of a device operable to perform data link group communication in accordance with the systems and methods of FIGS. 1-17.

### DETAILED DESCRIPTION

Particular aspects of the present disclosure are described below with reference to the drawings. In the description, common features are designated by common reference numbers.

Systems and methods for selective association are disclosed. For example, a first device included in a data link group may selectively associate with a second device of the data link group to wirelessly communicate messages, such as unicast messages, between the associated devices. As used herein, “associating” or “to associate” may include performing a security association (e.g., an authentication process) to enable unicast communication and/or peer-to-peer (P2P) communication, such as P2P communication using a pairwise key. The data link group may correspond to a data link group network that has a single-hop topology or a multi-hop topology. Rather than associating with each device of the data link group that is within communication range of the first device, the first device may associate with less than all of the devices within communication range of the first device. For example, the first device may identify a single particular device with which to associate. By associating with the single particular device, rather than each device of the data link group that is within the communication range of the first device, a number of messages exchanged between devices of the data link group may be reduced.

To illustrate, the first device may join the data link group and may receive a group key. To join the data link group, the first device may perform a single group authentication with a second device of the data link group to receive group authorization to join the data link group. As part of the single group authentication, the first device may receive the group key from the second device. The group key may enable the first device to engage in secure wireless communication of group addressed data messages, such as data messages that include broadcast content. The secure wireless communication may include secure broadcast communication and/or secure multicast communication, as illustrative, non-limiting examples. After completing the single group authentication to joining the data link group, the first device may send the group addressed data messages without associating with individual devices of the data link group.

The first device may use the group key to send a path request to a device(s) that is within communication range of the first device. For example, the first device (e.g., an originator device) may broadcast the path request to devices of the data link group. The path request may include data that indicates a destination device to which the path request is to be sent (and/or forwarded). The devices of the data link group may propagate the path request(s) to the destination device, and the destination device may send a path reply to the first device.

The first device may receive the path reply from a particular device (such as the second device) of the data link group. The first device may select the second device for association based on the path reply and may associate with the second device. Associating with the second device may include establishing a secure key, such as a pairwise key, between the first device and the second device to enable unicast messages to be wirelessly communicated (sent and received) between the first device and the second device. In some implementations, the first device may receive multiple path replies. For example, the first device may receive a first path reply from the second device and may receive a second path reply from a third device of the data link group. Each path reply may indicate a number of hops corresponding to a path between the first device and the destination device and/or a metric parameter, such as an amount of time for a message to be transmitted by the first device and received by the destination device, a bandwidth, etc. The first device may select one of the second device or the third device for association based on the first path reply and the second path reply, such as the path reply corresponding to the fewest number of hops and/or the shortest travel time.

In some implementations, the destination device may correspond to a service that is available via the data link group. For example, the service may include audio streaming, video streaming, data forwarding, or a combination thereof. To illustrate, the destination device of the data link group may be configured as a provider device that provides a service to other devices of the data link group. In some implementations, the second device may be the destination device. In other implementations, the second device may be a proxy device, such as a device that forwards data to and from the destination device.

One particular advantage provided by the disclosed aspects is that a service, such as proximity-based service, corresponding to the data link group may be securely and efficiently provided to devices of the data link group. For example, the service may be provided via a data link group network that corresponds to the data link group and that is included within a neighborhood-aware network (NAN) framework. The disclosed techniques may enable multi-hop service discovery and/or single-hop service discovery and may reduce a number of messages exchanged between devices to join the data link group.

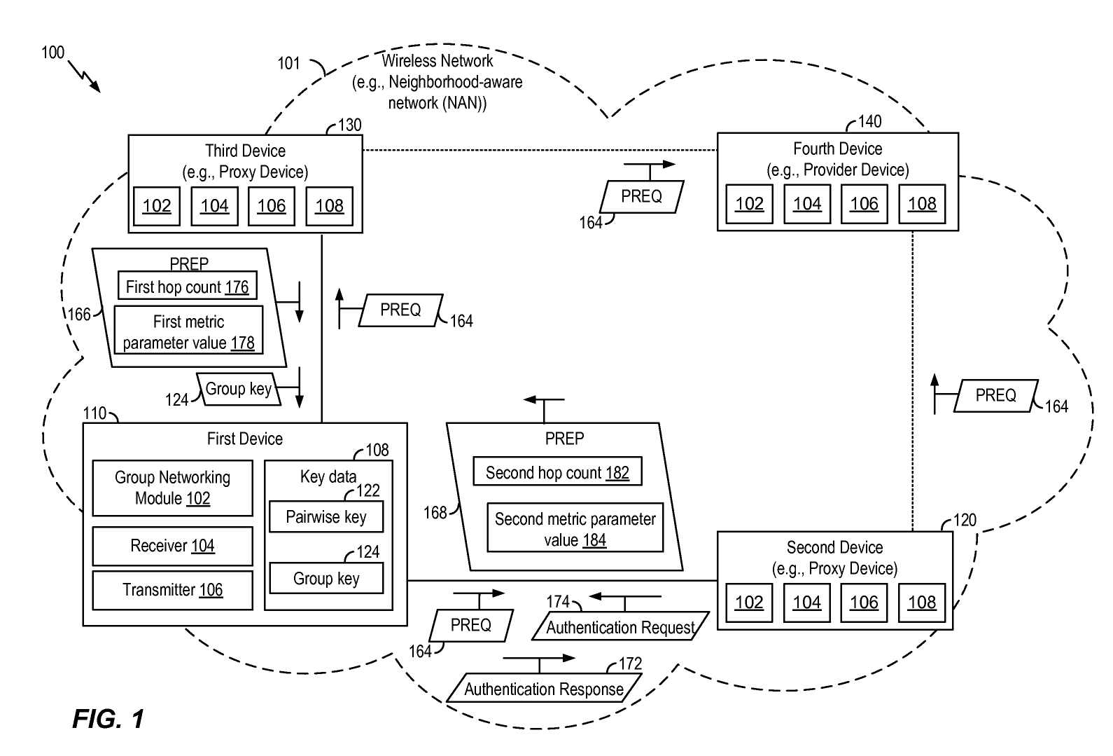

Referring to FIG. 1, a system that includes devices of a data link group is shown and generally designated 100. The system 100 includes a wireless network 101, such as a neighborhood-aware network (NAN). The system 100 includes a first device 110, a second device 120, a third device 130, and a fourth device 140. The devices 110, 120, 130, 140 may be included in a device cluster, such as a data link group. The data link group may include the wireless network 101 or a subset of the wireless network 101.

Each of the devices 110, 120, 130, 140 may be a wireless communication device configured to transmit data and/or to receive data from one or more other wireless communication devices included in the wireless network 101. The wireless network 101 may be an infrastructure network or an infrastructure-less network, such as a peer-to-peer network or an ad-hoc network, as illustrative, non-limiting examples. For example, each of the devices 110, 120, 130, 140 of the wireless network 101 may be configured to perform group authentication, association operations (e.g., security association operations), security information exchange operations, synchronization operations, and other operations via one or more wireless channels corresponding to the wireless network 101. In some implementations, the devices 110, 120, 130, 140 may perform such operations in accordance with one or more standards, such as an Institute of Electrical and Electronics Engineers (IEEE) 802.11 standard (e.g., a IEEE 802.11s standard), a Wi-Fi Alliance standard, and/or another standard (e.g., an infrastructure-less network standard), as illustrative, non-limiting examples. For example, the devices 110, 120, 130, 140 of the system 100 may be configured to communicate wirelessly according to one or more wireless communication protocols. To illustrate, the devices 110, 120, 130, 140 may send and receive discovery messages, such as beacons in connection with an IEEE 802.11 protocol. Additionally or alternatively, the devices 110, 120, 130, 140 of the system 100 may also communicate data, such as data corresponding to a particular application or service.

The wireless network 101 may include or correspond to one or more data link groups.

The data link group may also be referred to as a group, a data path group, a NAN data link (NDL) group, or a NAN data path group, as illustrative, non-limiting examples. The data link group may include multiple devices that are able to form a network, such as a data link group network. The data link group network may be a decentralized wireless network, such as an infrastructure-less peer-to-peer network, an ad-hoc network, or a mesh network, as an illustrative, non-limiting example. The data link group network may also be referred to as a group network, a data path group network, a NDL group network, or a NAN data path group network.

Each device of the data link group may use shared security credentials. The shared security credentials may be wirelessly communicated (e.g., exchanged between devices) in band or out of band of one or more group communication channels used by the data link group. In some implementations, the devices of the data link group may be synchronized to have periodic wake-up times, such as time periods when each of the devices is awake to advertise a service and/or to receive traffic and other messages.

The wireless network 101 may include or correspond to a data link group that includes the devices 110, 120, 130, 140. In a particular illustrative implementation, the devices 110, 120, 130, 140 may be configured to form a wireless mesh network, such as a “social wi-fi mesh” network, or a subset of the wireless mesh network, as an illustrative, non-limiting example. As part of the data link group, the devices 110, 120, 130, 140 may perform data exchanges via wireless communications. In some implementations, the data exchanges may not involve one or more wireless carriers, one or more Wi-Fi access points, and/or the Internet. For example, the devices 110, 120, 130, 140 of the data link group may share a security credential, such as a group key to enable communication. To illustrate, each device of the data link group may use the group key to encode and/or decode group messages. In some implementations, one or more services may be provided by one or more of the devices 110, 120, 130, 140 of the data link group to other devices of the data link group. The one or more services may include a music service, a social media sharing service, a file sharing service, and/or a data sharing service, as illustrative, non-limiting examples. Additionally or alternatively, the one or more services may include another service, such as a streaming service that is received at a provider device of the data link group and forwarded to other devices of the data link group.

Each data link group of the wireless network 101 may have a corresponding group identifier, such as a unique value. For example, the group identifier may include a byte value and/or a group address. Although the data link group in FIG. 1 is described as including four devices, in other implementations the data link group may include more than four devices or fewer than four devices. In some implementations, when the wireless network 101 includes multiple data link groups, a particular device may be included in more than one data link group.

In some implementations, a provider device (such as the fourth device 140) of the data link group may be configured to provide a service to other devices of the data link group. For example, the provider device may be located at a business and may be configured to provide advertisements to other devices (that join the data link group) that are within a particular distance of the business. To illustrate, a destination device may be located at a restaurant and may be configured to broadcast daily specials of the restaurant to other devices within communication range of the destination device. In some implementations, the fourth device 140 may be the provider device. In other implementations, the fourth device 140 may be a proxy device, such as a device that forwards data to and from the provider device.

As another example, the fourth device 140 may operate as a provider device by receiving service data, such as audio data, video data, or other data, and by forwarding the service data to other devices that may otherwise not have access to the service data. To illustrate, the fourth device 140 may have access to a particular network. The particular network may include a wireless network or a cellular network, as illustrative, non-limiting examples. The fourth device 140 may provide access to the particular network to devices that do not have access to the particular network, such as devices that are outside a range of the particular network, do not have a password to access the particular network, etc. Stated differently, the fourth device 140 may introduce the service data to the data link group to make the service data available to other devices of the data link group. For example, a user of the fourth device 140 at an airport may use the fourth device 140 to access a cellular network to receive a weather news stream. During an extreme weather event, multiple users at the airport may attempt to receive the same weather news stream; however, the cellular network may not have bandwidth to meet the high network demand. In this example, the fourth device 140 may operate as a provider device of a particular data link group and may forward data to the devices of the other users that join the data link group so that the other users at the airport may receive the weather news stream without having to access the cellular network.

In some implementations, the fourth device 140 may be a provider device of a service of the data link group and each of the second device 120 and the third device 130 may be a proxy device (of the data link group) of the service. To illustrate, each of the second device 120 and the third device 130 may be configured to receive data from the provider device (such as the fourth device 140) of the service and may forward the data to other devices. The second device 120 and/or the third device 130 may be within communication range of the fourth device 140 or may be multiple hops away from the fourth device 140. In this aspect, a device (such as the first device 110) that is not within a communication range of the provider device (such as the fourth device 140) of the service may receive data from the provider device via a proxy device (such as the second device 120 or the third device 130). Although the fourth device 140 has been described as being the provider device, in other implementations, more than one device may be considered a provider device. For example, each of the second device 120, the third device 130, and the fourth device 140 may be provider devices. In some implementations, a device of the data link group may be both a provider device and a proxy device (for another provider device of the data link group).

The first device 110 may include a group networking module 102, a receiver 104, a transmitter 106, key data 108, or a combination thereof. In a particular implementation, the second device 120, the third device 130, and/or the fourth device 140 may also include at least one of a group networking module 102, a receiver 104, a transmitter 106, and key data 108. The key data 108 of each of the devices 110, 120, 130, 140 may include at least one of a group key 124 and a pairwise key 122. The transmitter 106 of each of the devices 110, 120, 130, 140 may be configured to wirelessly transmit data (e.g., messages) to other devices of the data link group. The receiver 104 of each device 110, 120, 130, 140 may be configured to wirelessly receive data from other devices of the data link group. The group networking module 102 of each of the devices 110, 120, 130, 140 may be configured to perform one or more functions described herein with reference to operation of the device as part of the data link group. For example, the group networking module 102 may include circuitry and/or hardware configured to perform the one or more functions. To illustrate, the group networking module 102 may include a processor and a memory coupled to the processor. The memory may include one or more processor executable instructions that, when executed by the processor, cause the processor to perform one or more of the functions described herein.

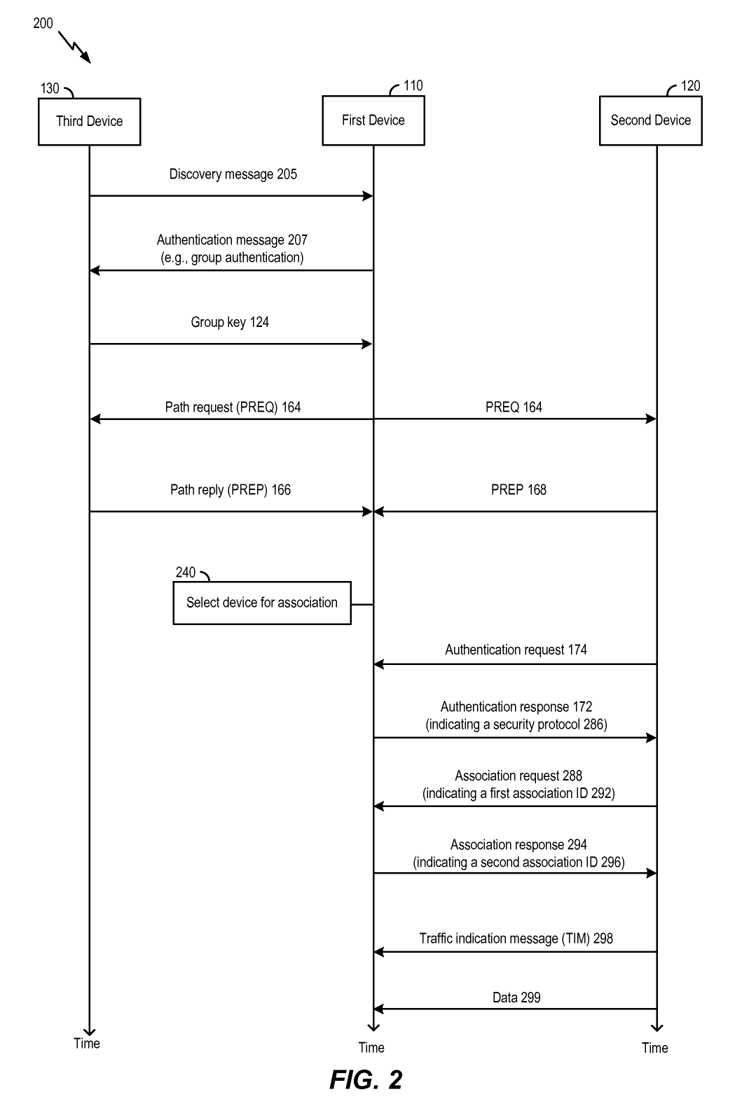

During operation, the first device 110 may join the data link group that includes the second device 120, the third device 130, and the fourth device 140. For example, the first device 110 may receive a discovery message (not shown) from the third device 130, as described with reference to FIG. 2. The discovery message may indicate availability of a service corresponding to the data link group. In some implementations, the service may correspond to an application of the third device 130. The discovery message may include data that indicates a group communication channel corresponding to the data link group, an identifier of a provider device (such as the fourth device 140) of the service, a second identifier of the third device 130, or a combination thereof, as illustrative, non-limiting examples. The identifier of the provider device may include a media access control (MAC) address of the provider device, and the second identifier may include a MAC address of the third device 130.

Responsive to the discovery message, the first device 110 may join the data link group.

To join the data link group, the first device 110 may perform a group authentication with a device of the data link group to receive authorization to join the data link group. For example, the first device 110 may receive the discovery message and may request to join the data link group. To join the data link group, the first device 110 may send an authentication message, such as a group authentication message, to the third device 130. Responsive to the authentication message, the first device 110 and the third device 130 may perform an authentication process, such as a single authentication for group authorization. If the third device 130 authenticates the first device 110, the third device 130 may send the group key 124 to the first device 110. For example, the third device 130 may generate the group key 124 (using an encryption key generation algorithm) and may transmit the group key 124 to the first device 110. The group key 124 may be used by the devices 110, 120, 130, 140 of the data link group to encrypt and decrypt data exchanged via the group communication channel of the data link group. For example, each of the devices 110, 120, 130, 140 may integrity protect data using the group key 124 and may verify received data (that is integrity protected) using the group key 124. In some implementations, the group key 124 may be used to encode data link group beacon messages and/or data link group announcement message that may be broadcast during group paging windows that corresponds to the group communication channel of the data link group. Additionally or alternatively, the group key 124 may be used to encode messages, such as broadcast messages or group addressed messages that may be transmitted using the group communication channel of the data link group.

After the first device 110 has completed the group authentication to join the data link group, the first device 110 may send and receive broadcast traffic corresponding to the data link group. However, to send (or receive) unicast traffic, such as unicast messages, the first device 110 may associate with a neighboring device of the data link group that is within communication range of the first device 110. As part of associating with the neighboring device, such as the second device 120 or the third device 130, the first device 110 may establish a security key with the neighboring device of the data link group that is within communication range of the first device 110. In some implementations, the security key may include a pairwise key, as an illustrative, non-limiting example. Accordingly, in such implementations, to use the service, the first device 110 may associate with another device of the data link group to send and receive unicast messages. Rather than associating with multiple devices (or all devices) with communication range of the first device 110, the first device 110 may select a particular device with which to associate, which may reduce messaging overhead of the data link group as compared to if the first device 110 associated with each device within communication of the first device 110 in response to joining the data link group.

In some implementations, the first device 110 may have received the group key 124 from the provider device. For example, the first device 110 may determine that a sender device identifier of the sender of the group key 124 matches a provider device identifier of the provider device as indicated by the discovery message received by the first device 110. In such situations, the first device 110 may associate with the provider device. If the sender device identifier does not match the provider device identifier, the first device 110 may recognize the sender device as a proxy device. In some implementations, the provider device (such as the fourth device 140) may be within a communication range of the first device 110 (but not yet known to the first device 110). For example, the fourth device 140 may be one-hop away from the first device 110. In other implementations, the provider device (such as the fourth device 140) may be multiple hops away from the first device 110 and may not be within communication range of the first device 110.

Prior to associating with another device of the data link group, the first device 110 may identify and select a particular device that is within communication range of the first device 110. The first device 110 may select the particular device based on path data that corresponds to a path that includes the particular devices. The first device 110 may receive the path data by sending a path request and receiving at least one path reply responsive to the path request, as described herein. The path data may indicate a number of hops of the path between the first device 110 and the provider device (such as the fourth device 140), an end-to-end transmission time via the path from the first device 110 to the provider device, a bandwidth of the path, a latency of the path, a packet loss value of the path, a reliability value of the path, a load of the path, or a combination thereof.

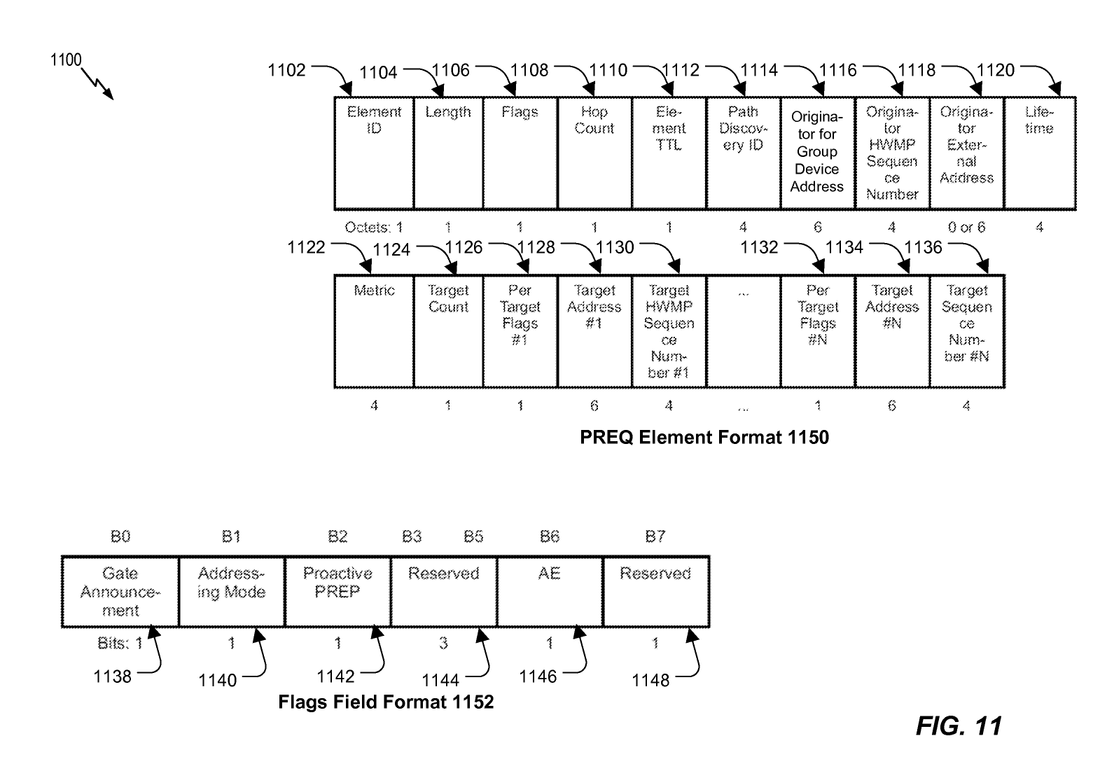

The first device 110 may generate and send a path requests (PREQ) 164 to one or more devices within communication range of the first device 110. The one or more devices may be unassociated with the first device 110. In some implementations, the first device 110 may send the PREQ 164 in response to determining that the sender device (of the group key 124) is a proxy device. The PREQ 164 may include destination data that indicates a destination device, such as the provider device. The destination data may indicate a MAC address (and/or other device identifier) of the provider device (such as the fourth device 140). Additionally or alternatively, the PREQ 164 may include path data, such as a hop count value that is set to a first initial value (e.g., 1) and/or a metric parameter that is set to a second initial value. The metric parameter may correspond to packet loss, bandwidth, latency, load, reliability, or a combination thereof, as illustrative, non-limiting examples. An illustrative example of a format of the PREQ 164 is described with reference to FIG. 11. In some implementations, the first device 110 may encode the PREQ 164 using the group key 124 and may send the encoded version of the PREQ 164.

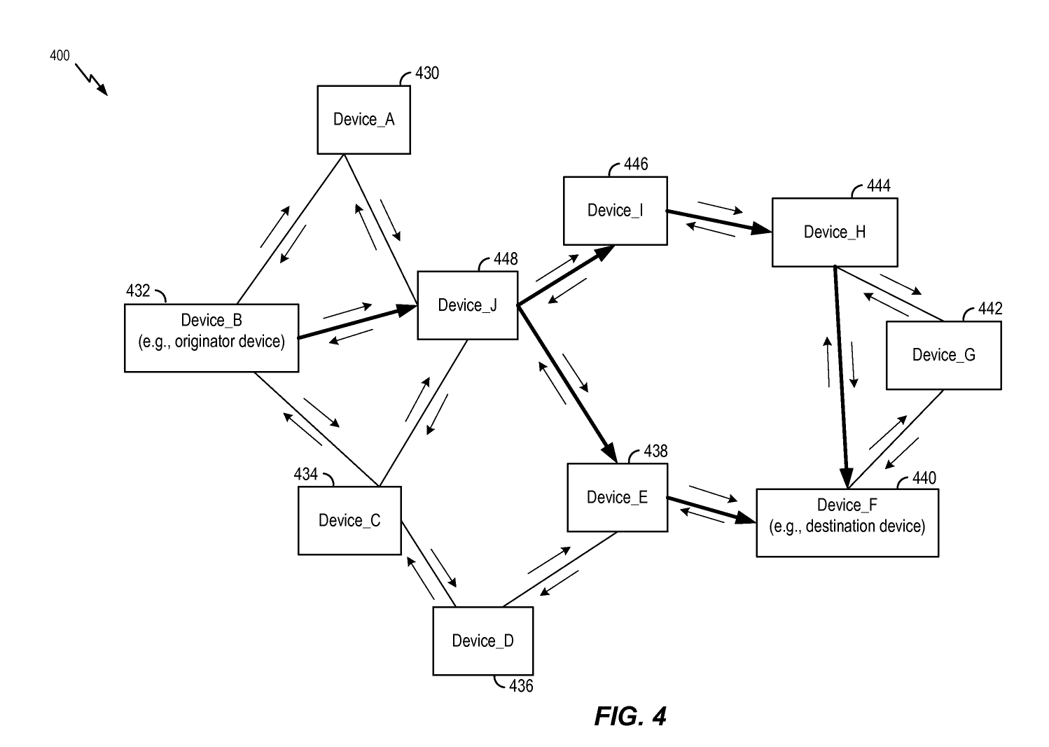

The second device 120 and the third device 130 may receive the PREQ 164. For example, each of the devices 120, 130 may receive the PREQ 164 during a group paging window of the group communication channel of the data link group. In some implementations, each of the devices 120, 130 may decrypt the PREQ 164 using the group key 124 even if the device 120, 130 is not associated with the first device 110. Each of the second device 120 and the third device 130 may determine whether it is the destination device of the PREQ 164 based on the destination data. If the device 120, 130 is the destination device, the device 120, 130 may generate a path reply, as described further herein. If the device 120, 130 is not the destination device, the device 120, 130 may forward the PREQ 164 to another device of the data link group, as described further with reference to FIG. 4. For example, one or more of the devices 120, 130 within the communication range of the first device 110 may forward the PREQ 164 to another device outside the communication range of the first device 110. Additionally or alternatively, each of the second device 120 and the third device 130 may update the path data of the PREQ 164 received by the device. For example, each of the second device 120 and the third device 130 may increment the hop count and/or update a value of the metric parameter of the PREQ 164 received by the device. The PREQ 164 forwarded by the second device 120 or the third device 130 may include the updated path data.

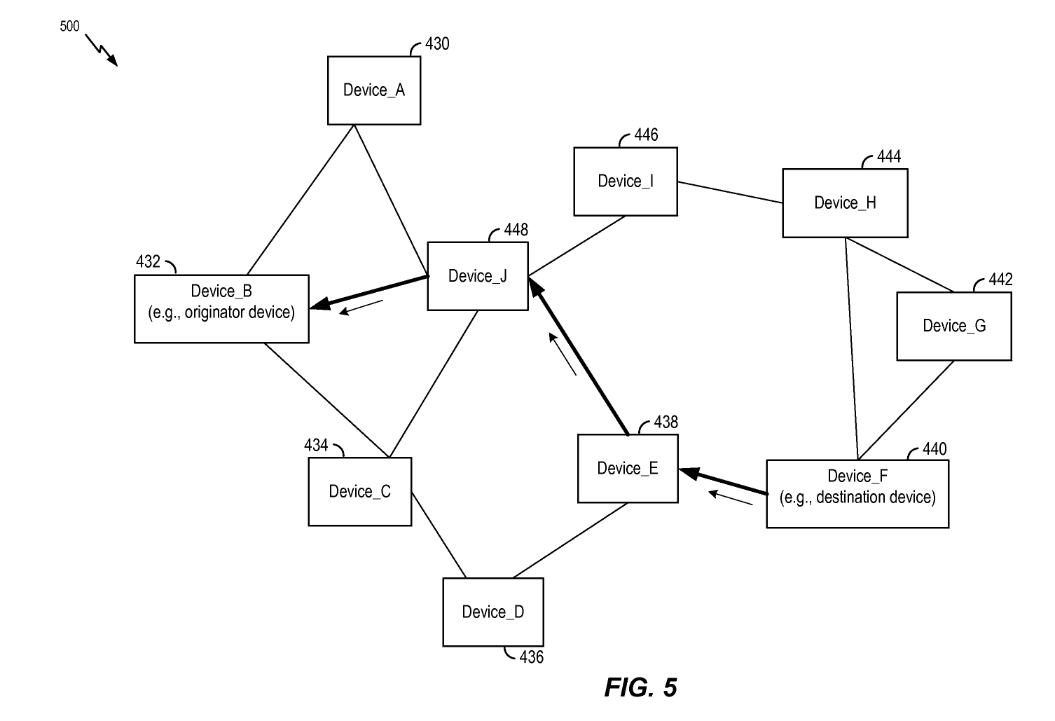

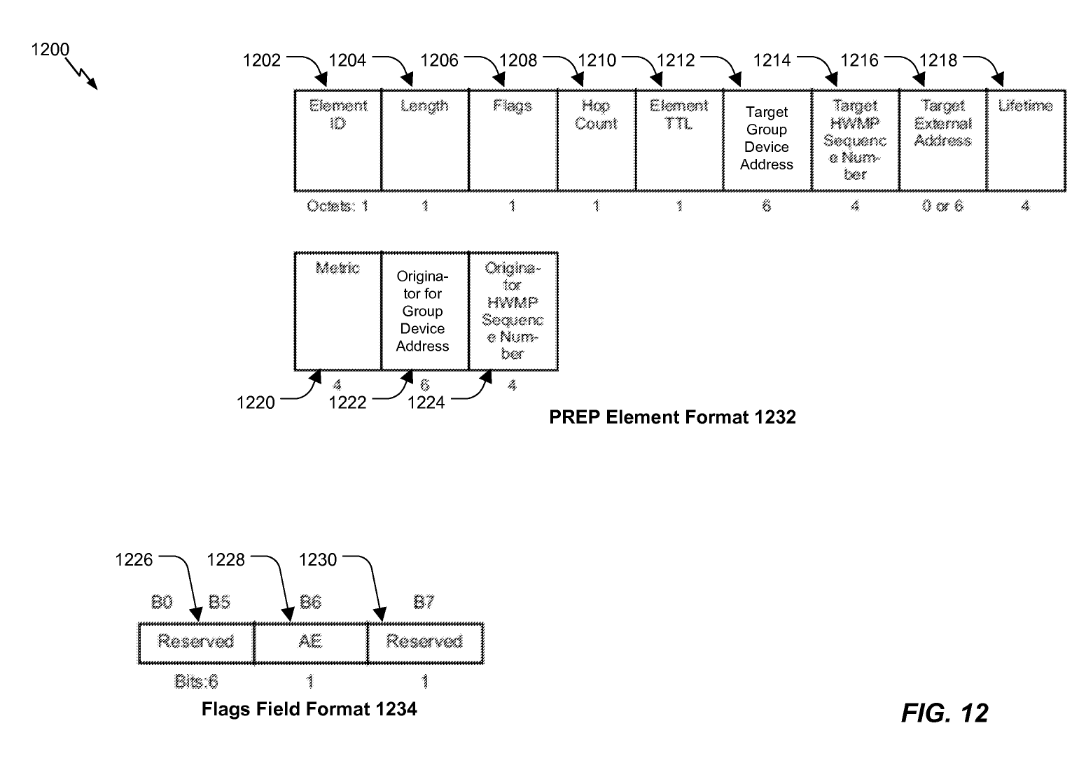

The fourth device 140 may receive one or more forwarded PREQs. For example, the fourth device 140 may receive the PREQ 164 forwarded by the third device 130 and the PREQ 164 forwarded by the second device 120. In response to receiving one or more PREQs 164, the fourth device 140 may generate and send a path reply (PREP), as described with reference to FIG. 5. A format of a PREP is described with reference to FIG. 12.

For example, the fourth device 140 may receive the PREQ 164 via a first path that includes the third device 130. In some implementations, the fourth device 140 may update the path data, such as the hop count and/or the metric parameter, in response to receiving the PREQ 164 from (or via) the third device 130. In response to receiving the PREQ 164 via the first path, the fourth device 140 may generate a PREP 166. To illustrate, the fourth device 140 may identify first path data included in the PREQ 164 received via the first path and may include the first path data (or the updated first path data) in the PREP 166. For example, the fourth device 140 may set a first hop count 176 of the PREP 166 based on the first path data, may set a first metric parameter value 178 (e.g., a first value of the metric parameter) of the PREP 166 based on the first path data, or both. The fourth device 140 may send the PREP 166 along the first path to the first device 110. For example, the PREP 166 may be sent (broadcast) via the group communication channel of the data link group during one or more group paging windows of the group communication channel. Each device along the first routing path may forward the PREP 166 to a next device via the group communication channel until the PREP 166 is received by the first device 110. In some implementations, the PREP 166 may propagate through the data link group as described with reference to FIG. 5.

As another example, the fourth device 140 may receive the PREQ 164 via a second routing path that includes the second device 120. In some implementations, the fourth device 140 may update the second path data of the PREQ 164 received from (or via) the second device 120. In response to receiving the PREQ 164 via the second path, the fourth device 140 may generate a PREP 168. To illustrate, the fourth device 140 may identify second path data included in the PREQ 164 received via the second path and may include the second path data (or an updated version of the second path data) in the PREP 168. For example, the fourth device 140 may set a second hop count 182 of the PREP 168 based on the second path data, may set a second metric parameter value 184 (e.g., a second value of the metric parameter) of the PREP 168 based on the second path data, or both. The fourth device 140 may send the PREP 168 along the second path to the first device 110. In some implementations, the PREP 168 may propagate through the data link group as described with reference to FIG. 5.

Each device of the data link group that sends the PREP 166 (or the PREP 168) may encrypt the PREP 166 (or the PREP 168) using the group key 124 prior to transmission. Each device of the data link group that receives the PREP 166 (or the PREP 168) may decrypt the PREP 166 (or the PREP 168) using the group key 124. Thus, devices that are not part of data link group may be unable to access (e.g., decrypt) the PREP 166 (or the PREP 168) even if the devices receive the PREP 166 (or the PREP 168) via the group communication channel of the data link group. To illustrate, the devices that are not part of the data link group may be unable to decrypt the PREP 166 (or the PREP 168).

The first device 110 may receive a plurality of PREPs, such as the PREP 166 and the

PREP 168. For example, the first device 110 may receive the PREP 166 from the third device 130 and may receive the PREP 168 from the second device 120. Each device that the first device 110 receives a PREP from may be identified as a candidate device for association. The first device 110 may select one of the second device 120 or the third device 130 based on the received PREPs, such as the PREP 166 and the PREP 168. For example, the first device 110 may select one of the second device 120 or the third device 130 for association based on the first path data (e.g., the first hop count 176 and/or the first metric parameter value 178) included in the PREP 166 and corresponding to the third device 130. Additionally or alternatively, the first device 110 may select the second device 120 or the third device 130 for association based on the second path data (e.g., the second hop count 182 and/or the second metric parameter value 184) included in the PREP 168 and corresponding to the second device 120. For example, each PREP received at the first device 110 may correspond to a path, such as a routing path including multiple hops or a single hop, from the first device 110 to the provider device. The first device 110 may compare the first path data included in the PREP 166 and/or the second path data included in the PREP 168 to each other, to one or more thresholds, or a combination thereof, to identify and select a particular device for association.

For example, the first device 110 may determine a lowest hop count of the plurality of received PREPs and may select a particular device that corresponds to the lowest hop count. As another example, the first device 110 may determine a lowest (or highest) metric parameter value of the plurality of received PREPs and may select a particular device that corresponds to the lowest (or highest) metric parameter value among the plurality of received PREPs. To illustrate, the first device 110 may determine the highest bandwidth value or the highest reliability measure among the plurality of received PREPs. Alternatively, the first device 110 may determine the lowest packet loss value among the plurality of received PREPs.

As another example, the first device 110 may reduce a number of candidate devices by comparing the hop counts and/or metric parameter values of the plurality of received PREPs to one or more thresholds. To illustrate, the first device 110 may remove candidate devices from consideration that have a corresponding hop count that fails to satisfy a hop count threshold. For example, if the first hop count 176 is greater than or equal to the hop count threshold (e.g., 10 hops), the third device 130 may be removed from being selected for association. Additionally, or alternatively, the first device 110 may remove a candidate device from consideration if a value of corresponding metric parameter fails to satisfy a metric threshold. For example, the first device 110 may remove a candidate device that does not have a corresponding bandwidth measure that is greater than or equal to a threshold bandwidth, a corresponding latency that is less than or equal a threshold latency value, a corresponding packet loss measure that is less than or equal to a threshold packet loss value, a corresponding reliability measure that is less than a threshold reliability value, and/or a corresponding load measure that is less than a threshold load value, as illustrative, non-limiting examples.

In response to determining that a single device is available for selection for association, the first device 110 may select the single device for association. Alternatively, if no devices are available for selection as a result of removing candidate devices, a previously removed device may be selected, such as a device corresponding to a lowest hop count among the plurality of received PREPs or a device from which the group key 124 was received, as illustrative, non-limiting examples. In some implementations, if no devices are available for selection as a result of removing candidate devices, the first device 110 may issue a second PREQ to receive a second set of PREPs to use to select a device for association.

If multiple candidate devices are available for selection, a combination of criteria (highest and/or lowest) and/or a combination of thresholds may be applied by the first device 110 to select a particular device. For example, the first device 110 may determine that each of the first hop count 176 and the second hop count 182 satisfies the particular hop count threshold. To illustrate, the particular hop count threshold may be equal to 10 hops, and a particular hop count may satisfy the particular hop count threshold if the particular hop count is less than or equal to the particular hop count threshold. The first device 110 may select the second device 120 (corresponding to the PREP 168) in response to determining that the second metric parameter value 184 is less (or greater) than the first metric parameter value 178. For example, the second metric parameter value 184 (e.g., a packet loss measure) may be less than the first metric parameter value 178 (e.g., a packet loss measure). As another example, the first device 110 may select the second device 120 in response to determining that the first metric parameter value 178 (e.g., a first reliability measure) has the same value as the second metric parameter value 184 (e.g., a second reliability measure) and that the second hop count 182 is less than the first hop count 176.

After selecting a particular device (such as the second device 120) for association, the first device 110 may associate with the particular device. For example, the first device 110 may select the second device 120 for association. The first device 110 and the second device 120 may perform an authentication process to make a security association that enables peer-to-peer (P2P) communication between the first device 110 and the second device 120. As part of the authentication process, the pairwise key 146 may be generated to enable secure communication between the first device 110 and the second device 120. The pairwise key 146 may be stored at each of the first device 110 and the second device 120.

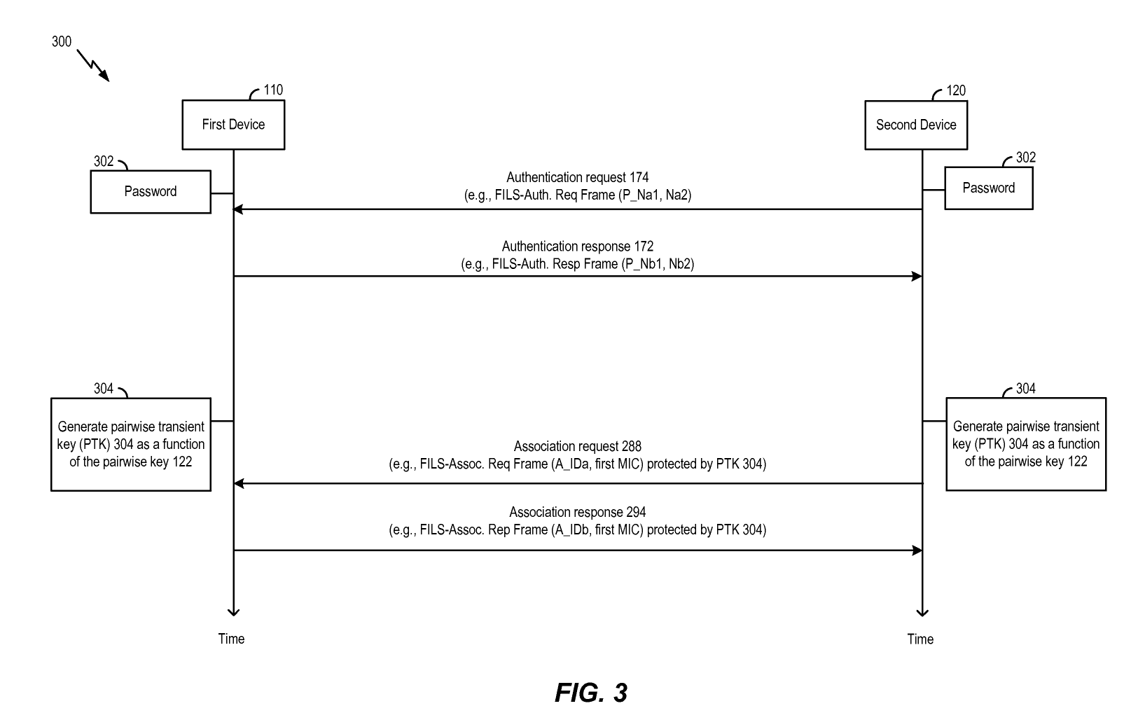

In some implementations, after selecting the particular device, the first device 110 may initiate associating with the particular device by sending an authentication request to the particular device. In other implementation, after selecting the particular device, the first device 110 may initiate associating by sending an authentication response to the particular device that is responsive to an authentication request received by the first device 110 from the particular device. For example, after selecting the second device 120 for association, the first device 110 may respond to an authentication request 174 received from the second device 120. To illustrate, the first device 110 may send the authentication response 172 (that is responsive to the authentication request 174) to the second device 120. In some implementations, the authentication request 174 may have been included in the PREP 168 sent from the second device 120 to the first device 110. If the authentication request 174 is included in the PREP 168, messaging overhead corresponding to the data link group may be reduced. Associating (and messaging corresponding to association) between the first device 110 and the second device 120 is described further herein with reference to FIGS. 2 and 3.

In some implementations, the authentication request 174 sent by the second device 120 may include data that indicate a crypto-suites supported by the second device 120. For example, the crypto-suites may include one or more security protocols, such as an encryption protocol, a key exchange protocol, an authentication protocol, or a combination thereof, as illustrative, non-limiting examples. The first device 110 may select one or more security protocols included in the crypto-suite. The authentication response 172 may include data that indicates the one or more security protocols selected by the first device. Accordingly, the first device 110 and the second device 120 may use the same security protocol to generate the pairwise key 122, as described with reference to FIGS. 2 and 3.

The system 100 of FIG. 1 may enable service discovery in a network having a single-hop topology or a multi-hip topology. For example, the first device 110 may discover that a service is available from the second device 120, the third device 130, and/or the fourth device 140. The system 100 of FIG. 1 may also reduce a number of messages exchanged between devices to join a data link group. For example, the first device 110 may join the data link group by associating with a single device (such as the third device 130) of the data link group. The first device 110 may select a particular device (such as the second device 120) and selectively associate with the particular device. For example, the first device 110 may select the particular device based on the PREQ 164 and a PREP 166, 168. The first device 110 may select the particular device based on a path to the destination device that is determined to be efficient. Associating with the particular device and communicating messages to the destination device via the particular device may reduce a number of messages exchanged between devices of the data link group.

Referring to FIG. 2, an illustrative example of a message exchange is shown and generally designated 200. The message exchange 200 may occur between devices of the data link group of the wireless network 101 of FIG. 1. For example, the message exchange 200 may occur between the first device 110, the second device 120, and the third device 130. The message exchange 200 is illustrated by a ladder diagram. The message exchange 200 may be used to enable the first device 110 to selectively associate with another device of the data link group.

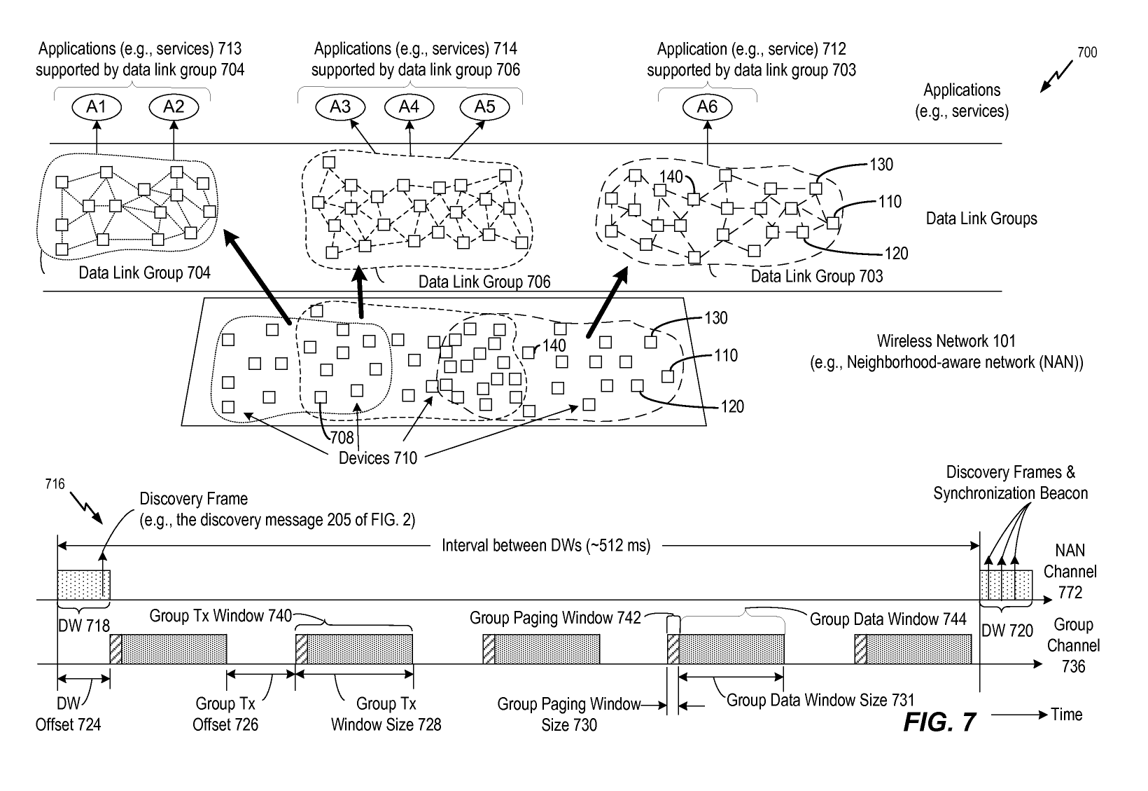

The third device 130 may initiate transmission, via the transmitter 106, of a discovery message 205. For example, the third device 130 may broadcast the discovery message 205 via a particular communication channel of the wireless network 101. The discovery message 205 may be sent to devices within communication range of the third device 130 during a time period, such as a discovery window corresponding to the wireless network 101, as described with reference to FIG. 7. The discovery message 205 may be a beacon message that corresponds to an IEEE 802.11 protocol. In some implementations, the third device 130 may periodically transmit the discovery message 205, such as during multiple discovery windows.

In some implementations, the discovery message 205 may include information that indicates a sending device of the discovery message 205, a service corresponding to the data link group, a provider device of the service, or a combination thereof, as illustrative, non-limiting examples. For example, the sending device may be indicated by a sender device identifier or a sender device MAC address, and the provider device may be identified by a provider device identifier or a provider device MAC address. In some implementations, the provider device of the service may include the fourth device 140 of FIG. 1 and/or another device, such as the second device 120, of the data link group. If the third device 130 is not the provider device, the discovery message 205 transmitted by the third device 130 may be based on a particular discovery message generate by the provider device. To illustrate, the provider device may generate the particular discovery message that indicates the service provided by the provider device, and the provider device may send the particular discovery message to other devices, such as the third device 130, included in the data link group. The third device 130 may receive the particular discovery message (or a forwarded version thereof) and may forward the particular discovery message (or a version thereof) as the discovery message 205.

Responsive to receiving the discovery message 205, the first device 110 may send an authentication message 207, such as a group authentication message, to the third device 130. Responsive to the authentication message 207, the first device 110 and the third device 130 may perform an authentication process, such as a single authentication for group authorization, and the third device 130 may send the first device the group key 124 of the data link group. After receiving the group key 124, the first device 110 may broadcast the PREQ 164 to devices within communication range of the first device 110. For example, the devices within the communication range of the first device 110 may include the second device 120 and the third device 130. The PREQ 164 may include data that indicates a destination device, such as the provider device of the service.

Responsive to the PREQ(s) 164, the first device 110 may receive the PREP 166 from the third device 130 and may receive the PREP 168 from the second device 120. Although the first device 110 is illustrated as receiving the PREP 166 and the PREP 168 at the same time, the first device 110 may receive the PREP 166 and the PREP 168 at different times. As an illustrative, non-limiting example, the PREP 166 may be received before or after the PREP 168.

The first device 110 may select a particular device for association, at 240. For example, the first device 110 may select to associate with the second device 120. The first device 110 may select to associate with one of the second device 120 or the third device 130 based on the PREP 166 and the PREP 168. The second device 120 may correspond to a path to the provider device (such as the fourth device 140) that is more efficient than an alternate path to the provider device via the third device 130. In some implementations, even though the first device 110 received the discovery message 205 from the third device 130 (corresponding to the PREP 166), the first device 110 may select the second device 120 (corresponding to the PREP 168). For example, the first device 110 may select the second device 120 based on the PREP 168 independent of whether the first device 110 received a discovery message from the second device 120.

The second device 120 may send the authentication request 174 to the first device 110.

Although the authentication request 174 is illustrated as being sent subsequent to the first device 110 selecting the particular device for association, in other implementations, the authentication request 174 may be sent prior to, during, and/or after the first device 110 selecting the particular device for association. In some implementations, the second device 120 may send the authentication request 174 concurrently with the PREP 168. For example, the second device 120 may send a single message that includes the path reply (PREP) 168 and the authentication request 174. Combining the PREP 168 and the authentication request 174 into the single message may use fewer messages and, thus, may reduce a communication overhead between the first device 110 and the second device 120. It is noted that although the message exchange 200 does not illustrate an authentication request being sent from the third device 130 to the first device 110, in some implementations, the third device 130 may send a corresponding authentication request to the first device 110.

The authentication request 174 may indicate physical (PHY) layer capabilities, MAC layer capabilities, or both, of the second device 120. For example, the authentication request 174 may indicate a crypto-suite supported by the second device 120. The crypt-suite may include one or more security protocols, such as an authentication protocol, a key exchange protocol, an encryption algorithm, or a combination thereof, as illustrative, non-limiting examples. In some implementations, the second device 120 may encrypt (e.g., encode) the authentication request 174 using the group key 124 and may send the encrypted version of the authentication request 174 via the group communication channel of the data link group during a group paging window of data link group. For example, the authentication request 174 may be integrity protected using the group key 124. Additionally or alternatively, the encryption of the authentication request 174 may be performed using an authenticated encryption (AE) cipher or an authenticated encryption with associated data (AEAD) cipher.

The first device 110 may receive the authentication request 174 from the second device 120 via the group communication channel of the data link group. If the authentication request 174 is encrypted, the first device 110 may decrypt (e.g., decode) the authentication request 174 using the group key 124. For example, if the authentication request 174 is integrity protected using the group key 124, the first device 110 may verity the authentication request 174 using the group key 124. In some implementations, the first device 110 may begin receiving the authentication request 174 during the group paging window and may continue to receive the authentication request 174 after the group paging window ends.

If the first device 110 selected the second device 120 for association, the first device 110 may generate an authentication response 172 to be sent to the second device 120. The authentication response 172 may be responsive to the authentication request 174. To generate the authentication response 172, the first device 110 may select a security protocol 286 of the crypto-suite supported by the second device 120. For example, the first device 110 may select the security protocol 286 based on determining that the security protocol 286 is supported by the first device 110. As another example, the security protocol 286 may indicate a particular crypto-suite (of multiple crypto-suites supported by the second device 120) selected by the first device 110. In a particular implementation, the security protocol 286 selected by the first device 110 may include a particular key exchange protocol, such as a password authenticated Diffie-Hellman (DH) key exchange protocol, as an illustrative, non-limiting example. The password authenticated DH key exchange protocol may be based on a simultaneous authentication of equals (SAE) authentication protocol. For example, as described with reference to FIG. 3, the password authenticated DH key exchange protocol may be a modified version of the SAE authentication protocol call-flow. The modified version of the SAE authentication protocol may be based on an IEEE 802.11ai based call-flow.

The authentication response 172 may include data that indicates physical layer capabilities, MAC layer capabilities, or both, of the first device 110. Additionally or alternatively, the authentication response 172 may include an indicator of the security protocol 286 (which may include or correspond to a particular key exchange protocol). The first device 110 may encrypt the authentication response 172 using the group key 124. The first device 110 may send the authentication response 172 via the group communication channel during the group paging window, after the group paging window, or both. For example, the first device 110 may begin sending the authentication response 172 during the group paging window and may finish sending the authentication response 172 during or after the group paging window ends.

The second device 120 may receive the authentication response 172 and may identify the security protocol 286 indicated by the authentication response 172. Accordingly, both first device 110 and the second device 120 may use the same security protocol, such as the same crypto-suite and/or the security protocol 286. The first device 110 and the second device 120 may generate the pairwise key 122 based on the security protocol 286, as described with reference to FIG. 3.

The message exchange 200 further includes the second device 120 sending the association request 288 to the first device 110. For example, the second device 120 may send the association request 288 in response to receiving the authentication response 172. The association request 288 may include a first association identifier (ID) (A_IDa) 292 generated by the second device 120. Additionally or alternatively, the association request 288 may include a first code, such as a first message integrity code (MIC). For example, the first code may be generated based on the pairwise key 122. In some implementations, the second device 120 may encrypt the association request 288 based on the group key 124. The second device 120 may send the association request 288 via the group communication channel during the group paging window, after the group paging window ends, or both. For example, the second device 120 may begin sending the association request 288 during the group paging window and may finish sending the association request 288 during or after the group paging window ends. As another example, the second device 120 may begin sending the association request 288 after the group paging window ends.

The first device 110 may receive the association request 288. In some implementations, the first device 110 may decrypt the association request 288 based on the group key 124. The first device 110 may store the first association ID (A_IDa) 292 at a memory of the first device 110. The first device 110 may generate a second code, such as a second MIC, based on the pairwise key 122, as further described with reference to FIG. 3. The first device 110 may verify the first code based on a comparison of the first code and the second code. For example, the first device 110 may determine that the first code is valid in response to determining that the first code matches (e.g., is the same as) the second code.

The message exchange 200 also includes the first device 110 sending an association response 294 to the second device 120. For example, the first device 110 may send the association response 294 in response to receiving the association request 288 and/or in response to verifying the first code matches the second code. The association response 294 may include a first association ID (A_IDb) 296 generated by the first device 110 and/or the second code. In some implementations, the first device 110 may encrypt the association response 294 using the group key 124. The first device 110 may send the association response 294 via the group communication channel during the group paging window, after the group paging window, or both. For example, the first device 110 may begin sending the association response 294 during the group paging window and may finish sending the association response 294 during or after the group paging window ends. As another example, the first device 110 may begin sending the association response 294 after the group paging window ends.

The second device 120 may receive the association response 294. In some implementations, the second device 120 may decrypt the association response 294 based on the group key 124. The second device 120 may store the second association ID (A_IDb) 296 at a memory of the second device 120. In response to receiving the association response 294 at the second device 120, the first device 110 and the second device 120 may be able to perform secure peer-to-peer (P2P) communication using the pairwise key 122. For example, data encrypted based on the pairwise key 122 may be inaccessible to other devices, such as other device of the data link group, which do not have the pairwise key 122.

The first device 110 may, after joining the data link group, monitor the group communication channel during group paging windows of the data link group. Traffic announcement messages (TIMs) may be broadcast during the group paging windows of the group communication channel. The TIMs may be encoded using the group key 124. As an example of a TIM, a first TIM sent by a device of the data link group may indicate that data (encoded using the group key 124) is to be broadcast to other devices of the data link group that are within communication range of the device. As another example of a TIM, a second TIM sent by the device may indicate that data will be sent, using a pairwise key, to a particular device.

The second device 120 may generate and send a TIM 298 that indicates that the second device 120 has data (such as data 299) to send to the first device 110. For example, the second device 120 may send the TIM 298 via the group communication channel of the data link group during a particular group paging window. One or more bits of the TIM 298 may correspond to the first association ID (A_IDa) 292, which may indicate to the first device 110 that the second device 120 has data to send to the first device 110.

In some implementations, the data 299 may correspond to the service provided by the provider device (such as the fourth device 140) of the data link group. For example, the second device 120 may receive the data 299 from the fourth device 140 and may forward the data 299 to the first device 110. In a particular implementation, the second device 120 may receive the data 299, may store the data 299 in the memory of the second device 120, and may generate the TIM 298. The second device 120 may transmit the TIM 298 during the particular group paging window. In some implementations, the second device 120 may encrypt the TIM 298 using the group key 124 and may send the encrypted version of the TIM 298.

If the first device 110 does not receive a TIM (such as the TIM 298) during the particular group paging window, the first device 110 may switch to a sleep mode during a subsequent group transmission window that follows the particular group paging window. If the first device 110 receives the TIM 298, the first device 110 may determine whether the TIM 298 indicates that the second device 120 has data to send to the first device 110. In response to determining that the second device 120 does not have data to send to the first device 110, the first device 110 may cease monitoring the group communication channel of the data link group during a subsequent group transmission window that follows the particular group paging window. For example, the first device 110 may switch to a sleep mode during the subsequent group transmission window. Alternatively, the first device 110 may stay awake during the subsequent group transmission window (independent of whether the second device 120 has data for the first device 110) if the first device 110 has data to transmit during the subsequent group transmission window.

In response to determining that the TIM 298 indicates that the second device 120 has data to send to the first device 110, the first device 110 may monitor the group communication channel during the subsequent group transmission window. For example, the first device 110 may remain in (or switch to) an active mode during the subsequent transmission window that immediately follows the group paging window during which the TIM 298 is sent. The second device 120 may encrypt the data 299 based on the pairwise key 122 and may transmit the data 299 during the subsequent group transmission window. Alternatively, the second device 120 may encrypt the data 299 based on the group key 124 and may transmit the data 299 during the subsequent group transmission window.

In some implementation, a particular device, such as the second device 120, may determine whether to broadcast or unicast the data 299, e.g., based on a number of devices that are within communication range of the second device 120 and that are associated with the second device 120. For example, the second device 120 may broadcast the data 299 in response to determining that a number (e.g., 2) of devices within communication range of the second device 120 satisfies (e.g., is greater than or equal to) a broadcast threshold having a value of 2. As another example, the second device 120 may unicast the data 299 in response to determining that a number (e.g., 1) of devices within communication range of the second device 120 fails to satisfy the broadcast threshold having a value of 2.

The particular device may encrypt the data 299 using the group key 124 in response to determining that the data 299 is to be broadcast. Alternatively, the particular device may encrypt the data 299 using a pairwise key in response to determining that the data 299 is to be unicast. For example, the second device 120 may encrypt the data 299 using the group key 124 prior to broadcasting. As another example, the second device 120 may encrypt the data 299 using the pairwise key 122 prior to unicasting to the first device 110.

In some implementations, if the first device 110 does not receive data (such as the data 299) that corresponds to the service within a particular duration of associating with the second device 120, the first device 110 may select and associate with another device (such as the third device 130). For example, the first device 110 may select the other device in response to determining that the data 299 has not been received from the second device 120 within a particular duration of sending the association response 294, within a particular duration of receiving the TIM 298, within the subsequent group transmission window (immediately following the group paging window during which the TIM 298 is transmitted), or a combination thereof To illustrate, the first device 110 may not receive data from the second device 120 if the second device 120 has disassociated from the data link group. In a particular implementation, the second device 120 may send a disassociation message to the first device 110, and the first device 110 may select to associate with the third device 130 responsive to the disassociation message.

In some implementations, after joining the data link group, the first device 110 may receive one or more authentication requests from multiple devices within communication range of the first device 110. The first device 110 may not respond to the one or more authentication requests until after the first device 110 selects the particular device for association. In response to selecting the particular device for association, the first device 110 may respond to at least one authentication request (from the particular device) of the one or more authentication requests. In some implementations, the first device 110 may respond to a single authentication request of the one or more received authentication requests. Additionally or alternatively, the first device 110 may select multiple devices for association. Each device that the first device 110 selects to associate with may be a device that sent a PREP to the first device 110.

In a particular implementation, each device along a path from the first device 110 to the provider device (such as the fourth device 140) may associate with a previous device and a next device along the path, as described with reference to FIG. 5. For example, a particular device along the path may establish a first pairwise key with a device along the path in a direction of the first device 110 and may establish a second pairwise key with a device along the path in a direction of the provider device. The first pairwise key may be used to exchange data between the particular device and the device along the path in the direction of the first device 110. The second pairwise key may be used to exchange data between the particular device and the device along the path in the direction of the provider device. Additionally or alternatively, the particular device may communicate with the device along the path in the direction of the first device 110 and/or may communicate with the device along the path in the direction of the fourth device 140 using the group key 124.

The message exchange 200 may enable two devices, such as the first device 110 and second device 120, of the data link group of the wireless network 101 to establish a pairwise key. The pairwise key may be distinct from the group key 124 of the data link group. The two devices may establish the pairwise key, may encrypt data based on the pairwise key, and may exchange the encrypted data. For example, message exchange 200 may enable the first device 110 to select a particular device for association.

Referring to FIG. 3, an illustrative example of a message exchange is shown and generally designated 300. The message exchange 300 may occur between devices of the data link group of the wireless network 101 of FIG. 1. For example, the message exchange 300 may occur between the first device 110 and the second device 120. In a particular implementation, the message exchange 300 may correspond to a password authenticated Diffie-Hellman (DH) key exchange protocol. The message exchange 300 is illustrated by a ladder diagram. The message exchange 300 may be used to establish the pairwise key 122 which may enable peer-to-peer (P2) communication, such as unicast messaging, between the first device 110 and the second device 120.

The message exchange 300 may use a modified version of a call-flow of a simultaneous authentication of equals (SAE) authentication protocol. For example, the message exchange 300 may be based on an IEEE 802.11ai based call-flow. The message exchange 300 authentication protocol, such as a fast initial link setup (FILS) protocol, may use fewer messages than a number of messages used by an unmodified version of the SAE authentication protocol to establish the pairwise key 122. For example, the message exchange 300 may use four messages as compared to eight messages used by the unmodified version of the SAE authentication protocol.

Each of the second device 120 and the first device 110 may have access to a common password. The password may be a default value or may be received via user input or from another device. In some implementations, the password may include the group key 124. Each of the second device 120 and the first device 110 may generate a corresponding password element 302 based on the password. For example, each of the second device 120 and the first device 110 may generate the password element 302 by applying a first key derivation function (KDF) to the password, a first MAC address of the first device 110, and a second MAC address of the second device 120, or a combination thereof.

The second device 120 may generate a first value (Na1) and a second value (Na2). For example, the first value (Na1) and the second value (Na2) may be distinct nonces. The second device 120 may generate a first public value (P_Na1) based on first value (Na1), the second value (Na2), or both. The first device 110 may generate a first value (Nb1) and a second value (Nb2). For example, the first value Nb1 and the second value (Nb2) may be distinct nonces. The first device 110 may generate a second public value (P_Nb1) based on first value (Nb1), the second value (Nb2), or both.

The message exchange 300 includes the second device 120 sending the authentication request 174 to the first device 110. For example, the second device 120 may generate the authentication request 174 that includes the second value (Na2), the first public value (P_Na1), or both. In some implementations, the second device 120 may generate a single nonce value (such as the first value (Na1)) and may generate the first public value (P_Na1) based on the single nonce value. In this implementation, the authentication request 174 may include the first public value (P_Na1) and may not include the second value (Na2).

The message exchange 300 also includes the first device 110 sending the authentication response 172 to the second device 120. For example, the first device 110 may generate the authentication response 172 in response to receiving the authentication request 174. The authentication response 172 may include the second value (Nb2), the second public value (P_Nb1), or both. In some implementations, the first device 110 may generate a single nonce value (such as the first value Nb1) and may generate the second public value (P_Nb1) based on the first value (Nb1). In this implementation, the authentication response 172 may include the second public value (P_Nb1) and may not include the second value (Nb2).

Each of the first device 110 and the second device 120 may generate the pairwise key 122 using a Diffie-Hellman (DH) key exchange protocol based on the first public value (P_Na1), the second public value (P_Nb1), the second value (Na2), the second value (Nb2), the password element 302, or a combination thereof. In some implementations, each of the first device 110 and the second device 120 may generate the pairwise key 122 using the first public value (P_Na1), the second public value (P_Nb1), and/or the password element 302, but not using the second value (Na2) and not using the second value (Nb2). Additionally, each of the first device 110 and the second device 120 may generate a pairwise transient key (PTK) 304 based on the pairwise key 122. For example, a second KDF may be applied to the pairwise key to generate the PTK 304. Each of the first device 110 and the second device 120 may generate a corresponding code, such as a message integrity code (MIC), based on the PTK 304. For example, the second device 120 may generate the first code (such as the first MIC) based on the PTK 304 generated by the second device 120. As another example, the first device 110 may generate the second code (such as the second MIC) based on the PTK 304 generated by the first device 110.

The message exchange 300 further includes the second device 120 sending the association request 288 to the first device 110. For example, the second device 120 may generate the association request 288 after receiving the authentication request 174. The association request 288 may include the first association ID (A_IDa) 292, the first code based on the PTK 304, or both, generated by the second device 120.

In response to receiving the association request 288, the first device 110 may verify the first code. For example, the first device 110 may determine that the first code is valid in response to determining that the first code matches the second code. The first device 110 may verify the first code to confirm that each of the first device 110 and the second device 120 has access to the same password element 302 and has derived the same pairwise key 122 and the same PTK 304.

The message exchange 300 also includes the first device 110 sending the association response 294 to the second device 120. For example, the first device 110 may generate the association response 294 in response to verifying the first code. The association response 294 may include the second association ID (A_IDb) 296, the second code based on the PTK 304, or both, generated by the first device 110.

The second device 120 may receive the association response 294. In a particular implementation, the second device 120 may verify the second code. For example, the second device 120 may determine whether the second code is valid based on a comparison of the first code and the second code. The second device 120 may verify the second code to confirm that each of the first device 110 and the second device 120 has access to the same password (such as the same group key 124) and has derived the same pairwise key 122 and the same PTK 304.

Although described as the second device 120 sending the authentication request 174, in other implementations, the first device 110 may send the authentication request 174. For example, the first device 110 may send the authentication request 174, the second device 120 may send the authentication response 172, the first device 110 may send the association request 288, and the second device 120 may send the association response 294. To illustrate, the first device 110 may send the authentication request 174 after selecting the second device 120 for association, as described with reference to FIGS. 1 and 2.

The message exchange 300 may enable two devices of the data link group of the wireless network 101 to establish a corresponding pairwise key. The pairwise key may be distinct from the group key 124 of the data link group. The devices may establish the pairwise key, may encrypt data based on the pairwise key, and may exchange the encrypted data.

Referring to FIG. 4, an illustrative example of a message exchange in a data link group is shown and generally designated 400. The data link group may correspond to the data link group of the wireless network 101 of FIG. 1. In a particular implementation, the message exchange 400 may occur among one or more of the devices 110, 120, 130, 140 of FIG. 1 to identify a path between an originator device (such as the first device 110) and a provider device (such as the fourth device 140) of a service of the data link group. The path may be a single-hop path or a multi-hop path.

The data link group may include devices 430-448. For example, the data link group may include a device_A 430, a device_B 432, a device_C 434, a device_D 436, a device_E 438, a device_F 440, a device_G 442, a device_H 444, a device_I 446, a device_J 448, or a combination thereof The device_B 432 may correspond to the first device 110 of FIG. 1 and the device_F 440 may correspond to the fourth device 140 of FIG. 1. In some implementations, the device _J 448 may correspond to the second device 120 of FIG. 1. Although the data link group is illustrated as including ten devices, in other implementations, the data link group may include more than or fewer than ten devices.

During operation, the device_B 432 may generate a PREQ indicating a destination device (such as the device_F 440) and having a hop count set to an initial value (e.g., 0). For example, the PREQ may include or correspond to the PREQ 164 of FIG. 1. The device_B 432 may send the PREQ to one or more receiving devices, such as the device_A 430, the device_C 434, and the device_J 448, within communication range of the device_B 432, as described with reference to FIGS. 1 and 2. A particular receiving device may discard the PREQ or may forward the PREQ to one or more receiving devices within communication range of the particular receiving device, which may in turn forward or discard the PREQ 164. Prior to the particular device forwarding the PREQ, the particular device may update (e.g., increment) the hop count of the PREQ. Additionally or alternatively, prior to forwarding the PREQ, the particular device may add a device ID and/or a MAC address of the particular device to the PREQ.

To illustrate, the device_E 438 may receive a first PREQ via the device_D 436 prior to receiving a second PREQ via the device_J 448. The first PREQ may indicate a first hop count to the device_B 432 (the originator device). The device_E 438 may forward the first PREQ to one or more devices, such as the devices the device_D 436, the device J 448, and/or the device_F 440, within communication range of the device_E 438 in response to determining that no PREQs indicating device_B 432 as the originator device have been previously received. Additionally or alternatively, the device_E 438 may forward the first PREQ in response to determining that the first hop count is less than a particular hop count in a previously received PREQ that indicated device_B 432 as the originator device.

The device_E 438 may receive the second PREQ after forwarding the first PREQ received via the device_D 436. The device_E 438 may forward the second PREQ to the one or more devices within communication range of the device_E 438. For example, the device_E 438 may forward the second PREQ in response to determining that the PREQ 164 received via the device _J 448 indicates a second hop count to the device_B 432 and that the second hop count is less than the first hop count. Alternatively, the device_E 438 may not forward and/or discard the second PREQ in response to determining that the second hop count is greater than or equal to the first hop count.

The device_F 440 (the destination device) may receive one or more PREQs from one or more devices within communication range of the device_F 440. For example, the device_E 438, the device_G 442, and/or the device_H 444 may be within the communication range of the device_F 440. The device_F 440 may respond to at least one of the one or more PREQs. For example, the device_F 440 may generate a PREP in response to a particular PREQ, as described with reference to FIG. 5. In some implementations, the device_F 440 may generate a PREP for each PREQ corresponding to the device_B 432 and received by the device_F 440. In other implementations, the device_F 440 may discard a received PREQ, and may not generate a PREP for the discarded PREQ.

The message exchange 400 may enable an originator device to send a PREQ to a destination device, such as a provider device, over a single hop or multiple hops to determine a path to the destination device. In some implementations, one or more devices, such as intermediate devices along the path or the destination device, may discard the PREQ when the PREQ is received from a less optimal path, thereby reducing a communication overhead related to identification and/or selection of the path.

Referring to FIG. 5, an illustrative example of a message exchange in a data link group is shown and generally designated 500. The data link group may correspond to the data link group of the wireless network 101 of FIG. 1 and/or to the data link group of FIG. 4. For example, the message exchange 500 may occur as part of or as a continuation of the message exchange 400 of FIG. 4.

To illustrate, the device_B 432 may send the PREQ, and the device_F 440 may receive the PREQ from one or more devices within communication range of the device_F 440, as described with reference to FIG. 4. For example, the device_F 440 may receive a third PREQ via the device_E 438 that indicates a first hop count (e.g., 2), may receive a fourth PREQ via the device_H 444 that indicates a second hop count (e.g., 3), and may receive a fifth PREQ via the device_G 442 that indicates a third hop count (e.g., 4). The third PREQ received by the device_F 440 may correspond to a first path that includes the device_B 432, the device J 448, the device_E 438, and the device_F 440. The fourth PREQ received by the device_F 440 may correspond to a second path that includes the device_B 432, the device J 448, the device_I 446, the device_H 444, and the device_F 440. The fifth PREQ received by the device_F 440 may correspond to a third path that includes the device_B 432, the device J 448, the device_I 446, the device_H 444, the device_G 442, and the device_F 440.

In a particular implementation, the device_F 440 may receive multiple PREQs from a single device. For example, the device_F 440 may receive a sixth PREQ via the device_E 438 that indicates fourth hop count (e.g., 3). To illustrate, the device_E 438 may forward sixth PREQ received via the device_D 436 prior to forwarding the third PREQ received via the device_J 448. The sixth PREQ received by the device_F 440 that includes the fourth hop count may correspond to a fourth path that includes the device_B 432, the device_C 434, the device_D 436, the device_E 438, and the device_F 440.

In response to receiving each PREQ, the device_F 440 may update (e.g., increment by 1) a hop count of the PREQ. Alternatively, in other implementations, the device_F 440 may not update the hop count of a particular PREQ in response to receiving the particular PREQ. The device_F 440 may generate one or more PREPs, such as the PREP 166 or 168 of FIG. 1, in response to receiving PREQs from one or more devices of the data link group. For example, the device_F 440 may receive the fourth PREQ via the device_H 444 before receiving PREQs via other devices. The device_F 440 may generate a first PREP in response to receiving the fourth PREQ and may send the first PREP via the device_H 444 to the device_B 432. In a particular implementation, the device_F 440 may associate with the device_H 444 in response to receiving the fourth PREQ via the device_H 444. For example, the device_F 440 may establish a pairwise key with device_H 444, as described with reference to FIGS. 2 and 3.

The device_F 440 may also receive the fifth PREQ via the device_G 442 after receiving the fourth PREQ via the device_H 444. In response to receiving the fifth PREQ, the device_F 440 may discard the fifth PREQ based on determining that the third hop count (e.g., 4) is greater than the second hop count (e.g., 3). In a particular implementation, the device_F 440 may not associate with the device_G 442 in response to determining that the third hop count is greater than the second hop count.

The device_F 440 may receive the sixth PREQ (that indicates the fourth hop count) via the device_E 438 after receiving the fifth PREQ via the device_G 442. In response to receiving the sixth PREQ, the device_F 440 may discard the sixth PREQ based on determining that the fourth hop count (e.g., 3) is greater than or equal to the second hop count (e.g., 3). In some implementations, the device_F 440 may not associate with the device_E 438 in response to determining that the fourth hop count is greater than or equal to the second hop count.

The device_F 440 may receive the third PREQ (that indicates the first hop count) via the device_E 438 after receiving the sixth PREQ (that indicates the fourth hop count) via the device_E 438. In response to receiving the third PREQ, the device_F 440 may generate a second PREP based on determining that the first hop count (e.g., 2) is less than the second hop count (e.g., 3). The device_F 440 may send the second PREP via the device_E 438 to the device_B 432. In a particular implementation, the device_F 440 may associate with the device_E 438 in response to determining that the first hop count is less than the second hop count. For example, the device_F 440 may establish a pairwise key with device_E 438.

An intermediate device, such as a device other than the originator device and other than the destination device, may receive multiple PREPs. For example, the device _J 448 may receive the first PREP (received via the device_I 446) and the second PREP (received via the device_E 438) from the device_F 440. In a particular implementation, the device _J 448 may forward each of the multiple PREPs to the originator device (such as the device_B 432). In an alternative implementation, the device_J 448 may discard a particular PREP in response to determining that the particular PREP is less optimal than another PREP that was previously forwarded to be provided to the originator device. For example, the device_J 448 may receive the second PREP prior to receiving the first PREP. The device_J 448 may forward the second PREP to the device_B 432 in response to determining that no PREPs were previously forwarded to the device_B 432. Subsequently, the device_J 448 may receive the first PREP and may discard the second PREP by suppressing and/or not forwarding the first PREP.

In a particular implementation, the intermediate device may associate with another device in response to determining that a PREP is to be forwarded to the other device. For example, the device_J 448 may associate with the device_B 432 in response to determining that the second PREP is to be forwarded to the device_B 432. To illustrate, the device_J 448 and the device_B 432 may establish a pairwise key, such as the pairwise key 122 of FIG. 1. As another example, an intermediate device (such as the device_E 438) may forward a PREP to another intermediate device (such as the device_J 448) on the path to the originator device. If device_E 438 and device_J 448 are not associated, the device_E 438 may associate with the device_J 448 in response to determining that the PREP is to be forwarded to the device_J 448. For example, the device_E 438 may establish a pairwise key with device_J 448.

In a particular implementation, an intermediate device that forwards the PREP may not initiate association with a device that the intermediate device forwards the PREP to; rather, the device that receives the PREP forwarded from the intermediated device may determine whether to associate with the intermediate device by sending an authentication request. For example, if the device_J 448 and the device_E 438 are not associated, the device_J 448 may, in response to receiving a PREP from the device_E 438, send an authentication request to initiate association with the device_E 438. The device_E 438 may send an authentication response to the device_J 448, after which the device_J 448 and the device_E 438 may establish a pairwise key for secure communication between the device J 448 and the device_E 438.

In a particular implementation, the device _J 448 may receive the second PREP after receiving the first PREP. In response to receiving the second PREP, the device _J 448 may forward the second PREP to the device_B 432 based on determining that a first hop count corresponding to the first PREP is greater than a second hop count corresponding to the second PREP. Alternatively, if the first hop count is greater than or equal to the second hop count, the device_J 448 may discard the second PREP based on determining that.

The originator device may receive multiple PREPs. For example, the device_B 432 may receive a third PREP via the device_C 434 prior to receiving a fourth PREP via the device_J 448. In response to receiving the third PREP, the device_B 432 may select the device_C 434 that corresponds to a first path via the device_C 434. In response to receiving the second PREP, the device_B 432 may select the device_J 448 that correspond to a second path via the device _J 448 in response to determining that a second hop count corresponding to the fourth PREP is less than a first hop count corresponding to the third PREP. Alternatively, the device_B 432 may discard the fourth PREP in response to determining that the second hop count is greater than or equal to the first hop count.

The particular implementations illustrated in FIGS. 4 and 5 are discussed in terms of hop counts. In an alternative implementation, a device may discard or forward a PREQ, and/or a PREP based on a hop count, one or more thresholds, one or more metric parameters (as described with reference to FIG. 1), or a combination thereof

The message exchange 500 may enable an originator device to receive one or more PREPs from a destination device over multiple hops to determine a routing path to the destination device. Some intermediate devices may discard a PREP when the PREP represents a less optimal path, thereby reducing a communication overhead related to selecting the routing path.

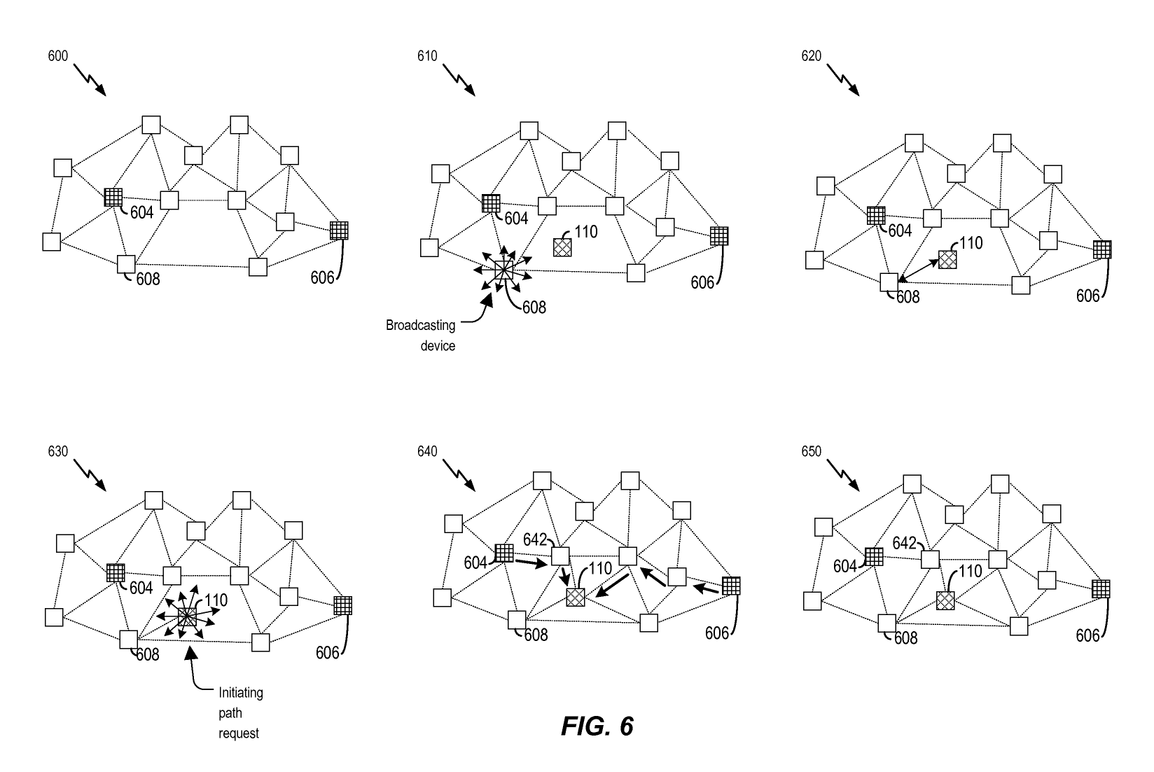

Referring to FIG. 6, states of a particular data link group are shown. In a particular implementation, the states may correspond to a data link group that includes the devices 110, 120, 130, 140 of FIG. 1 or the devices 430-448 of FIGS. 4 and 5.

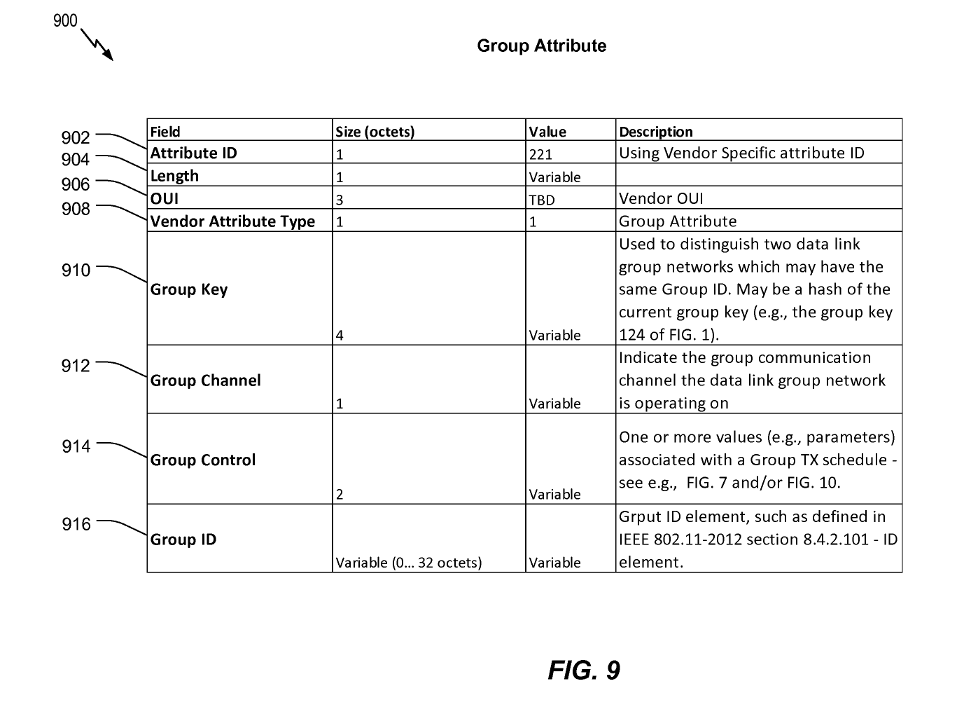

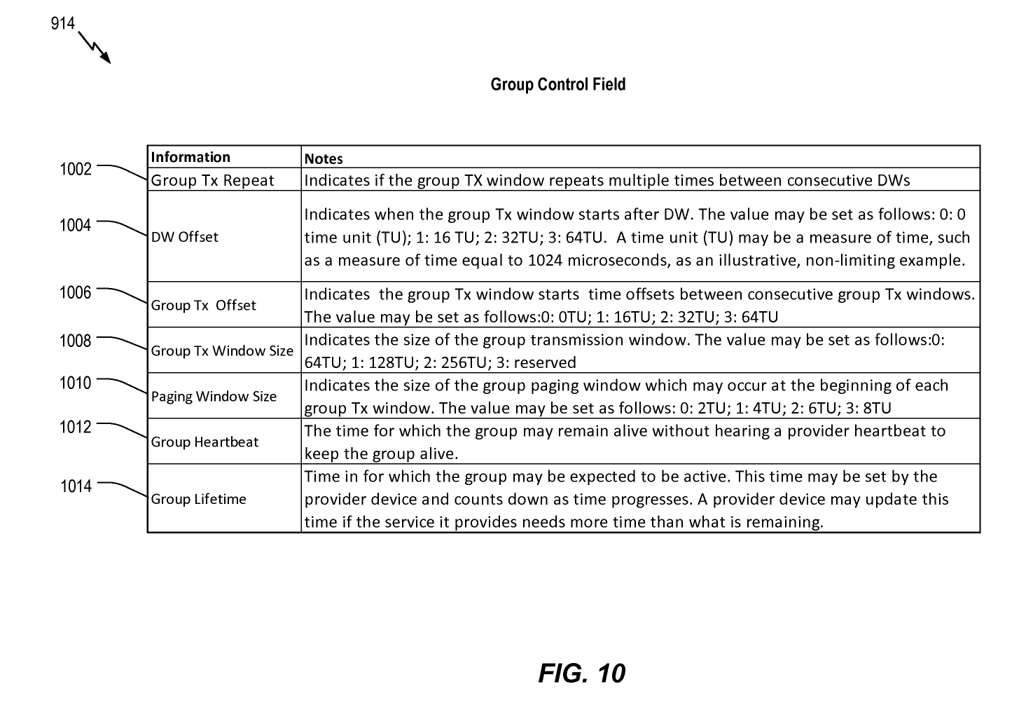

A plurality of devices, including one or more provider devices, may participate in a data link group, at 600. The plurality of devices may include a first provider device 604, a second provider device 606, and a proxy device 608. The plurality of devices may be synchronized via beaconing on a particular communication channel of a wireless network that includes the data link group. Additionally, the devices of the data link group may be synchronized via a secondary discovery message. For example, the secondary discovery message may include a group control field that specifies a transmission schedule, as described with reference to FIGS. 9 and 10.

The first device 110 may enter communication range of the proxy device 608 participating in the data link group, at 610. The first device 110 may receive a service broadcast message from the proxy device 608 that is transmitted by the proxy device 608 to devises within communication range of the proxy device 608. In some implementations, the proxy device 608 may correspond to the third device 130 of FIG. 1 and the service broadcast message may correspond to the discovery message 205 of FIG. 2. The service broadcast message may advertise availability of a service (provided by the first provider device 604 and/or the second provider device 606) that is available via the data link group.

The first device 110 may join the data link group by associating with the proxy device 608, at 620. For example, the first device 110 may authenticate with the second device and, upon authentication, the first device 110 may receive a group key of the data link group from the proxy device 608.

The first device 110 may initiate association route discovery to reach one or more provider devices, at 630. For example, the first device 110 may initiate route discovery to select a particular device of the data link group for association. In some implementations, the first device 110 may issue one or more path requests (PREQs), such as the PREQ 164 of FIG. 1, to identify a route to the first provider device 604 and/or a second path to the second provider device 606. In some implementations, the one or more PREQs may be encoded using the group key.

The first device 110 may receive path replies (PREPs) from devices of the data link group, at 640. The PREPs received may include a first PREP that corresponds to the first provider device 604 and a second PREP that corresponds to the second provider device 606. In some implementations the PREPs may be encoded with the group key and the first device 110 may decode the PREPs using the group key stored at the first device 110. The first device 110 may select a particular device 642 from which it received the first PREP and may associate with the particular device 642. Accordingly, the first device 110 may send data to and receive data from the first provider device 604 via the first path that includes the particular device 642.

Group paging windows of a group communication channel may be used to coordinate sleep times of one or more devices included in the data link group, at 650. The devices of the data link group may not use the group communication channel to send beacon messages, such as discovery message, to coordinate sleep times. Sleep times may be coordinated based on the data link group control field of a discovery message, such as the discovery message 205 of FIG. 2, which may specify a time and a duration of group paging windows of the group communication channel, as described with reference to FIG. 10. For example, after joining the data link group, the devices of the data link group may stay awake during the group paging windows specified by the data link group control field to monitor the group communication channel.

If a particular device (such as the first device 110) does not receive a TIM during a particular group paging window or determines that the TIM does not indicate data to be sent to the particular device, the particular device may sleep through a subsequent group data window (or a remainder of a group transmission widow that includes the particular group paging window) and may sleep until a next group paging window (or a next discovery window). Alternatively, the particular device may be in an active mode through group data window to transmit and/or receive data corresponding to a service of the data link group. In some implementations, routing messages (e.g., PREQ and PREP), authentication messages (e.g., the authentication message 207), new group key announcements, association messages (e.g., the authentication request 174, the authentication response 172, the association request 288, or the association response 294), explicit disassociation messages, or a combination thereof, may be sent during group paging windows since devices of the data link group are awake during the group paging windows.

The states illustrated in FIG. 6 may enable a particular device of the data link group to selectively associate with another device of the data link group. Additionally, the particular device may conserve power by switching to (or remaining in) a low power mode, such as a sleep mode, through group data windows during which there is no data to be sent to or from the particular device. Alternatively, the states of FIG. 6 may enable the particular device be in an active mode through group data window to transmit and/or receive data corresponding to a service of the data link group.

Referring to FIG. 7, a particular example of a system is shown and generally designated 700. The system 700 may include the wireless network 101. The wireless network 101 may include multiple devices, such as representative devices 710 and the devices 110, 120, 130, 140 of FIG. 1. Additionally or alternatively, the wireless network 101 may include one or more of the devices the devices 430-448 of FIG. 4 and/or one or more of the devices of the data link group of FIG. 6.

The multiple devices of the wireless network 101 may be synchronized to enable the multiple devices to wake up periodically. For example, the devices may wake up by switching to an active mode during certain time periods, such as discovery windows of the wireless network 101. Each of the multiple devices may monitor the same particular communication channel of the wireless network 101 during the discovery windows. The wireless network 101 may be identified by a network identifier (ID), such as a NAN cluster identifier (ID). The network ID may be selected by a device that initiates formation of the wireless network 101 and may be included in messages, such as discovery messages.

A subset of the devices of the wireless network 101 may transmit synchronization beacons and/or discovery beacons over the particular communication channel of the wireless network 101. Discovery messages and the synchronization beacons may be transmitted by one or more of the devices during the discovery windows over the particular communication channel. A discovery message, such as the discovery message 205 of FIG. 2, may be used by a device (not included in the wireless network 101) to discover the wireless network 101 and to enable the device to join the wireless network 101. A synchronization beacon may be used by the multiple devices of the wireless network 101 for time synchronization function (TSF) correction.

In some implementations, the wireless network 101 may have a tree structure anchored at a particular device (called an anchor master) of the wireless network 101. A timing of the anchor master may be propagated to each of the devices of the wireless network 101 via synchronization (synch) devices and master devices, such as NAN master devices. The synch devices and the master devices may provide time synchronization within the wireless network 101.

There may be one or more data link groups, such as a first data link group 703, a second data link group 704, and a third data link group 706, included in the wireless network 101. In a particular implementation, the data link groups 703, 704, and 706 may correspond to distinct applications, distinct types of devices, distinct operating systems, or a combination thereof.

In a particular implementation, the data link group as described with reference to FIG. 1 may correspond to the first data link group 703. For example, the first data link group 703 may include the devices 110, 120, 130, 140 of FIG. 1. In some implementations, a device may be included in multiple data link groups. To illustrate, the particular device 708 may be included in the second data link group 704 and in the third data link group 706.

In some implementations, the first data link group 703 may include a first subset of the multiple devices, the second data link group 704 may include a second subset of the multiple devices, and the third data link group 706 may include a third subset of the devices 410. The subsets may overlap or may be distinct. To illustrate, the particular device 708 may be a provider device of a first service of the second data link group 704, may be a proxy device of a second service of the third data link group 706, may be a consumer device of the first service, the second service, and/or a third service of the first data link group 703, or a combination thereof.

In some implementations, a particular data link group may correspond to a service or multiple services, such as a service supported by a single application or multiple services supported by multiple applications. For example, each of the data link groups 703, 704, 706 may correspond to one or more services. To illustrate, the first data link group 703 may correspond to a single application 712, such as an application (A6), the second data link group 704 may correspond to multiple applications 713, such as applications (A1-A2), and the third data link group 706 may correspond to multiple applications 714, such as applications (A3-A5), as an illustrative, non-limiting example.

A particular device (such as the fourth device 140) of the first data link group 703 may advertise availability of a service that corresponds to the application (A6). To advertise the service, the particular device may send a discovery message via the particular communication channel of the wireless network 101. In response to receiving the discovery message, one or more devices may join the first data link group 703 to receive the service corresponding to the application (A6). A device that joins the first data link group 703 may receive a group key of the first data link group 703. The group key of the first data link group 703 may be distinct from group keys of the second data link group 704 and the third data link group 706.

FIG. 7 also illustrates an illustrative example of a transmission schedule 716. In some implementations, the transmission schedule 716 may correspond to the wireless network 101 and/or a group communication channel of a data link group, such as the first data link group 703. The wireless network 101 may correspond to a particular communication channel 772 and the first data link group 703 may correspond to a group communication channel 736. Referring to the first data link group 703, a device included in the first data link group 703 may generate a data link group control field, as described with reference to FIGS. 9 and 10, to represent the transmission schedule 716. The device may include the data link group control field in a discovery message, such as the discovery message 205 of FIG. 2, transmitted by the device to other devices in communication range of the device. For example, the device may generate the group control field to represent the transmission schedule 716 corresponding to a group communication channel 736 of the first data link group 703. The device may include the group control field in the discovery message and may transmit the discovery message message to advertise availability of a service provided via the group communication channel 736.

The particular communication channel 772 may include discovery windows, such as a first discovery window 718 and a second discovery window 720. In some implementation, there may be a time interval of approximately 512 milliseconds (ms) between consecutive discovery windows. The discovery windows 718, 720 may be used by devices of the wireless network 101 to send discovery frames and synchronization beacons. For example, the fourth device 140 may send a discovery message to advertise the service corresponding to the application (A6) during the first discovery window 718, the second discovery window 720, or both.

In between consecutive discovery windows, one or more group transmission (TX) windows, such a representative group TX window 740, of the group communication channel 736 may occur. An initial group TX window of the one or more group TX windows may begin after a discovery window (DW) offset 724. The DW offset 724 may be a particular duration between a beginning (or an end) of the first discovery window 718 and a beginning of the initial group TX window of the group communication channel 736. Each group TX window may have a group TX window size 728 that is a size (e.g., a duration) of the group TX window. Each group TX window may include a group paging window 742 and a group data window 744. Each group paging window may have a group paging window size 730 and each group data window may have a group data window size 731. A group TX offset 726 may indicate a duration between consecutive group TX windows that occur between a set of consecutive discovery windows.

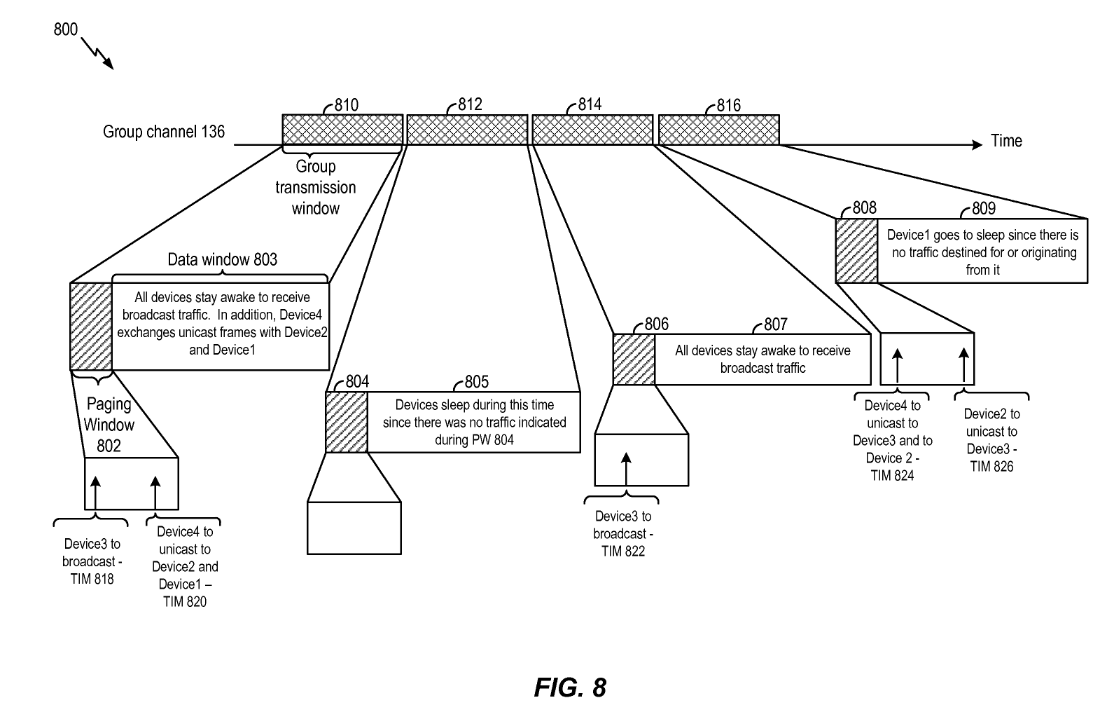

Referring to FIG. 8, an illustrative example of a message exchange is shown and generally designated 800. In a particular implementation, the message exchange 800 may include devices of a data link group, such as a first device (Device1), a second device (Device2), a third device (Device3), and a fourth device (Device4). For example, the devices may include one or more of the devices 110, 120, 130, 140 of FIG. 1, the devices the devices 430-448 of FIG. 4, the devices of the data link group of FIG. 6, and/or the devices of the first data link group 703 of FIG. 7. The message exchange 800 may occur using the group communication channel 736.

The devices of the data link group may be synchronized via one or more synchronization beacons that are communicated by a master device of the data link group or a master device of the wireless network 101 that includes the data link group. For example, one of the devices of the data link group may be the master device and may broadcast one or more synchronization beacons to other devices included in the wireless network 101 via the particular communication channel 772.

The devices may be synchronized to detect group transmission windows corresponding to the group communication channel 736. For example, each of the devices of the data link group may have synchronized clocks, as described by the IEEE 802.11s standard and/or a Wi-Fi Alliance standard, to enable correct determinations of when group transmission windows, group paging windows, and/or group data windows begin and end. The group transmission windows may include a first group transmission window 810, a second group transmission window 812, a third group transmission window 814, and a fourth group transmission window 816. Each of the group transmission windows may include a corresponding group paging window and a corresponding group data window. To illustrate, the first group transmission window 810 may include a first group paging window 802 and a first group data window 803, the second group transmission window 812 may include a second group paging window 804 and a second group data window 805, the third group transmission window 814 may include a third group paging window 806 and a third group data window 807, and the fourth group transmission window 816 may include a fourth group paging window 808 and a fourth group data window 809.

During a group paging window, each of the devices of the data link group may be awake (e.g., not in a power-save or sleep mode) and may monitor for beacons and/or messages indicating traffic (to be sent during a corresponding group data window). Beacons and/or messages sent during the group paging window may be secure (e.g., encoded) or un-secure (e.g., un-encoded). When a secure beacon and/or a secure message is transmitted during the group paging window, the secure beacon and/or the secure message may be encoded using a key, such as a group key or a pairwise key. If a particular device determines that it may receive data based on the beacons and/or messages received during the group paging window, the particular device may stay awake during the corresponding group data window. If the particular device does not receive a beacon and/or a message indicating upcoming data during the group paging window, the particular device may go to sleep (e.g., enter a sleep mode or power-save mode) during the following group data window. If the particular device does not receive a beacon and/or a message indicating upcoming data during the group paging window, the particular device may be awake to transmit data during the following group data window.

Referring to the first group paging window 802, the third device (Device3) may send a TIM 818 that indicates that the third device (Device3) has data to broadcast to the data link group. Additionally, the fourth device (Device4) may send a TIM 820 that indicates that the fourth device (Device4) has data to send to the first device (Device1) and to the second device (Device2). During the first group data window 803, all the devices that received the TIM 818 may stay awake to receive broadcast traffic. Additionally, the fourth device (Device4) may transmit unicast frames to the first device (Device1) and to the second device (Device2). Devices of the data link group that did not receive the TIM 818 may not be awake during the first group data window 803.

In the example illustrated in FIG. 8, during the second group paging window 804, no beacons or messages are communicated. Accordingly, during the second group data window 805, the devices of the data link group may be in a sleep mode. During the third group paging window 806, the third device (Device3) may transmit a TIM 822 that indicates the third device (Device3) has data to broadcast. Accordingly, all of the devices of the data link group within communication range of the third device (Device3) may be awake during the third group data window 807.

During the fourth group paging window 808, the fourth device (Device4) may send a TIM 824 that indicates that the fourth device (Device4) has data to send to the third device (Device3) and to the second device (Device2). Additionally, the second device (Device2) may send a TIM 826 that indicates that the second device (Device2) has data to send to the third device (Device3). During the fourth group data window 809, the fourth device (Device4) may transmit unicast frames to the second device (Device2) and to the third device (Device3). Additionally, the second device (Device2) may send one or more unicast frames to the third device (Device2). Other devices, such as the first device (Device1) of the data link group, may not be awake during the fourth group data window 809.

Thus, FIG. 8 illustrates how devices may send beacons and/or messages during group paging windows of group transmission windows to inform other devices of the data link group of data traffic to be transmitted. By informing other devices of the data traffic to be transmitted, one or more devices that are not intended to send or receive the data traffic may conserve power by entering a sleep mode or a power-save mode, or may send data or receive data with one or more devices of another data link group during a group data window.

Referring to FIG. 9, a diagram of a particular example of a group attribute is shown and generally designated 900. In a particular implementation, the group attribute 900 may be included in the discovery message 205 of FIG. 2, such as in a field of the discovery message 205 of FIG. 2. In some implementations, the group attribute 900 may be generated by the fourth device 140 or the third device 130 of FIG. 1 and may be received by the first device 110.

The group attribute 900 may include an attribute identifier (ID) field 902, a length field 904, an organizational unique identifier (OUI) field 906, a vendor attribute type field 908, a group key field 910, a group channel field 912, a group control field 914, a group identifier (ID) field 916, or a combination thereof. The attribute ID field 902, the length field 904, the vendor attribute type field 908, the group channel field 912, or a combination thereof, may each be 1 octet (e.g., 8 bits) long, as an illustrative, non-limiting example. The OUI field 906 may be 3 octets (e.g., 24 bits) long, as an illustrative, non-limiting example. The group key field 910 may be 4 octets (e.g., 32 bits) long, as an illustrative, non-limiting example. In some implementations, the group control field 914 may be 2 octets (e.g., 16 bits) long.

In a particular implementation, the group ID field 916 may have a variable length. For example, the group ID field 916 may be between 0 and 32 octets (e.g., 0 to 656 bits) long, as an illustrative, non-limiting example. A device that receives the group attribute 900 may determine a length of the group ID field 916 based on the length field 904 of a received discovery message, such as the discovery message 205 of FIG. 2, that includes the group attribute 900.

Referring to FIG. 2, the first device 110 may determine that the discovery message 205 includes the group attribute 900 based on the vendor attribute type field 908 having a particular value (e.g., 1), the attribute ID field 902 having a particular value (e.g., 221), the OUI field 906 having a particular value, or a combination thereof, as an illustrative, non-limiting example. The first device 110 may extract information regarding the data link group from the discovery message 205 in response to determining that the discovery message 205 includes the group attribute 900. The first device 110 may extract information regarding the data link group (e.g., the first data link group 703) from the discovery message 205 in response to determining that the discovery message 205 includes the group attribute 900.

The first device 110 may determine an identifier of the data link group of FIG. 1 based on a value of the group ID field 916. The first device 110 may determine the group key 124 based on a value of the group key field 910. For example, the value of the group key field 910 may correspond to a hash of the group key 124. In some implementations, the wireless network 101 may include multiple data link groups, as described with reference to FIG. 7. For example, the wireless network 101 may include one data link group for each service offered by a device of wireless network 101. In such implementations, multiple data link groups of the wireless network 101 may correspond to a single value of the group ID field 916. In this implementation, the first device 110 may distinguish between the multiple data link groups based on the value of the group key field 910.

A device that receives the group attribute 900 may determine the group communication channel of the data link group based on a value of the group channel field 912. The group control field 914 is further described with reference to FIG. 10. The group attribute 900 may enable use of a discovery message to advertise availability of a service via a particular group communication channel of the wireless network 101, such as the particular communication channel 772.

Referring to FIG. 10 a diagram of an illustrative example of a group control field is shown and generally designated 914. In a particular implementation, the group control field 914 may be included in the group attribute 900 of FIG. 9. The group control field 914 may include a group transmission (TX) repeat field 1002, a discovery window (DW) offset field 1004, a group TX offset field 1006, a group TX window size field 1008, a group paging window size field 1010, a group heartbeat field 1012, a group lifetime field 1014, or a combination thereof.

A value of the DW offset field 1004 may indicate that a first group transmission window begins after a particular duration following an end (or a beginning) of a discovery window. A value of the group TX repeat field 1002 may indicate whether group transmission windows are repeated multiple times between consecutive discovery windows. A value of the group TX offset field 1006 may indicate a particular duration between an end of a particular group transmission window and a beginning of a next group transmission window. A value of the group TX window size field 1008 may indicate a size of each group transmission window. Each group transmission window includes a group paging window at a beginning of the group transmission window. A value of the group paging window size field 1010 may indicate a particular duration of each group paging window. A value of the group heartbeat field 1012 may indicate a heartbeat value. A value of the group lifetime field 1014 may indicate a lifetime value. The lifetime value may indicate a particular duration that the service is expected to be available via the data link group. The group heartbeat field 1012 may indicate that the first device 110 is to disassociate from the data link group in the absence of receiving a discovery message during a particular duration corresponding to the heartbeat value. The first device 110 may disassociate from the data link group based on the heartbeat value, the lifetime value, or both.

The group control field 914 may enable a device (such as the fourth device 140) to specify a transmission schedule corresponding to the group communication channel 736. A receiving device, such as the third device 130 or the first device 110, may monitor the group communication channel 736 according to the transmission schedule 716 indicated by the group control field 914.

Referring to FIG. 7, the value of the DW offset field 1004 may indicate a DW offset 724 of the transmission schedule 716. The DW offset 724 may be a particular duration between an end of the first discovery window 718 and a beginning of the second discovery window 720. The value of the group TX repeat field 1002 may indicate that multiple group transmission windows are repeated between consecutive discovery windows.

The value of the group TX offset field 1006 may indicate a group TX offset 726 of the transmission schedule 716. The group TX offset 726 may be a particular duration between consecutive group transmission windows. The value of the group TX window size field 1008 may indicate a group TX window size 728 of the transmission schedule 716. The group TX window size 728 may be a size of each group transmission window. The value of the group paging window size field 1010 may indicate a group paging window size 730 of the transmission schedule 716. The group paging window size 730 may be a size of a group paging window that occurs at a beginning of a group transmission window. In a particular implementation, there may be a time interval of approximately 512 milliseconds (ms) between consecutive discovery windows.

In some implementations, a particular discovery window may be used to send discovery frames and synchronization beacons. For example, the fourth device 140 may send a discovery message during the first discovery window 718, the second discovery window 720, or both. As another example, the third device 130 may send the discovery message 205 during the first discovery window 718, the second discovery window 720, or both.

Referring to FIG. 11, a particular implementation of a format of a path request (PREQ) is shown and generally designated 1100. In a particular implementation, the PREQ may correspond to the PREQ 164 of FIG. 1.

The format 1100 includes a PREQ element format 1150 and a flags field format 1152.

The PREQ element format 1150 may correspond to a format of the PREQ 164 of FIG. 1. The PREQ element format 1150 includes an element ID field 1102, a length field 1104, a flags field 1106, a hop count field 1108, an element time-to-live (TTL) field 1110, a path discovery identifier (ID) field 1112, and an originator group device address field 1114. Additionally, the PREQ element format 1150 includes an originator hybrid wireless group protocol (HWMP) sequence number field 1116, an originator external address field 1118, a lifetime field 1120, a metric field 1122, a target count 1124, a first target flags field 1126, a first target address field 1128, a first target HWMP sequence number field 1130, a nth target flags field 1132, a nth target address field 1134, and a nth target sequence number field 1136.

Each of the element ID field 1102, the length field 1104, the flags field 1106, the hop count field 1108, the element time-to-live (TTL) field 1110, the target count 1124, the first target flags field 1126, and the nth target flags field 1132 may have a length of 1 octet, as an illustrative, non-limiting example. Each of the path discovery identifier (ID) field 1112, the originator hybrid wireless mesh protocol (HWMP) sequence number field 1116, the lifetime field 1120, the metric field 1122, the first target HWMP sequence number field 1130, and the nth target sequence number field 1136 may have a length of 4 octets, as an illustrative, non-limiting example. Each of the originator group device address field 1114, the originator external address field 1118, the first target address field 1128, and the nth target address field 1134 may have a length of 6 octets, as an illustrative, non-limiting example. In some implementations, the originator external address field 1118 may have a length of 0 octets, as an illustrative, non-limiting example. For example, the PREQ element format 1150 may not include the originator external address field 1118.

The flags field format 1152 may correspond to the flags field 1106. The flags field format 1152 includes a gate announcement field 1138, an addressing mode field 1140, a proactive PREP field 1142, a reserved field 1144, an address extension (AE) field 1146, and a reserved field 1148, as illustrative, non-limiting examples.

During operation, the first device 110 may generate a PREQ according to the PREQ element format 1150. For example, the first device 110 may initialize the PREQ by setting the originator group device address field 1114 to a MAC address of the first device 110, setting the originator HWMP sequence number field 1116 to a particular value identifying the PREQ 164, and setting the path discovery ID field 1112 to a particular value identifying a particular path. The first device 110 may set the element TTL field 1110 to a number of hops after which the PREQ is to be discarded, may set the lifetime field 1120 to a particular time unit after which the PREQ is to be discarded, may initialize the hop count field 1108 to a particular value (e.g., 0), and may initialize the metric field 1122 to a particular value (e.g., 0). The first device 110 may use the PREQ to determine paths to one or more destination devices, such as the fourth device 140.

The first device 110 may set the target count field 1024 to indicate a number (e.g., 1 to 20) of destination devices. The first device 110 may set target specific fields for each destination device. For example, the first device 110 may set the first target address field 1128 to indicate an address, such as a specific MAC address or a broadcast MAC address, of a first destination device and may set the nth target address field 1134 to indicate an address of an nth destination device. The first device 110 may have a previously received HWMP sequence number of a destination device. For example, the first device 110 may have previously received a PREP with the HWMP sequence number of the destination device (such as the fourth device 140). The first device 110 may set a target HWMP sequence number field to the previously received HWMP sequence number of the destination device. To illustrate, the first device 110 may set the first target HWMP sequence number field 1130 to the previously received HWMP sequence number of the first destination device. As another example, the first device 110 may set the nth target sequence number field 1136 to the previously received HWMP sequence number of the nth destination device.

The first device 110 may set a target flags field for each destination device. For example, the first device 110 may set the first target flags field 1126 for the first destination device, may set the nth target flags field 1132 for the nth destination device. Each target flags field (e.g., the first target flags field 1126 or the nth target flags field 1132) may include a target only flag field of a particular length (e.g., 1 bit), as an illustrative, non-limiting example. The first device 110 may set a first target only flag field of the first target flags field 1126 to a first value (e.g., 1) to indicate that only the first destination device is to respond to the PREQ with a PREP. Alternatively, the first device 110 may set an nth target only flag field of the nth target flags field 1132 to a first value (e.g., 1) to indicate that only the nth destination device is to respond to the PREQ with a PREP. The first device 110 may set the first target only flag field to a second value (e.g., 0) to indicate that an intermediate device (such as a proxy device) along a route to the destination device is to respond to the PREQ with a PREP.

The first device 110 may transmit the PREQ to devices of the data link group. For example, the first device 110 may broadcast the PREQ via the group communication channel 736 during a group data window. A receiving device of the data link group may receive the PREQ from the first device 110. The receiving device may update (e.g., decrement by 1) the value of the element TTL field 1110 and may update (e.g., increment by 1) the value of the hop count field 1108.

The receiving device may determine a particular metric parameter value based on the receiving device and the device that sent the PREQ to the receiving device. In a particular implementation, the metric parameter value of the PREQ may indicate a first average packet loss. The receiving device may determine a second average packet loss, during a particular duration (e.g., a previous 5 minutes), between the receiving device and the device that sent the PREQ to the receiving device.

The receiving device may update the metric parameter value of the PREQ to indicate the second average packet loss in response to determining that the second average packet loss is higher than the first average packet loss. In this implementation, the metric parameter value of the PREQ may indicate a lowest (or highest) metric parameter value along a path. For example, the lowest (or highest) metric parameter value may correspond to a congested portion of the path, an error-prone portion of the path, or both.

In other implementations, the metric parameter value of the PREQ may indicate a cumulative metric parameter value, such as a cumulative value of the metric parameter. For example, the receiving device may update the metric parameter value of the PREQ by adding a second metric parameter value to the metric parameter value of the PREQ. In this example, the metric parameter value of the PREQ may correspond to a sum of metric parameter values along the path. As another example, the receiving device may update the metric parameter value of the PREQ by averaging a second metric parameter value and the metric parameter value of the PREQ. In this example, the metric parameter value of the PREQ may correspond to an average of metric parameter values along the route.

The receiving device may create (or update) path information to an originator device (such as the first device 110) of the PREQ. For example, the receiving device may create the path information in response to determining that another PREQ from the same originator device has not been previously received. The path information may indicate the value of the metric field 1122, the value of the originator group device address field 1114, the value of the originator HWMP sequence number field 1116, the value of the hop count field 1108, the value of the originator external address field 1118, an identifier (e.g., a MAC address) of the originator device, or a combination thereof

As another example, the receiving device may update the path information of the originator device in response to determining that the value of the originator HWMP sequence number field 1116 of the PREQ is greater than a value of an originator HWMP sequence number field indicated in the path information, that the value of the metric field 1122 is greater (or less) than the value of the metric field indicated in the path information, or both. In some implementations, the receiving device may forward the PREQ in response to creating or updating the path information of the originator device and determining that the value of the lifetime field 1120 and the value of the element TTL field 1110 are unexpired.

The receiving device may discard (e.g., not forward) the PREQ in response to determining that the value of the lifetime field 1120 is expired, the value of the element TTL field 1110 is expired, or both. Additionally or alternatively, the receiving device of the data link group may not generate a path reply (PREP) in response to determining that the path information of the destination device indicated by the PREQ is inaccessible or that the target only flag field of the corresponding target flags field indicates a second value (e.g., 1).

Alternatively, the receiving device may generate a PREP in response to determining that path information of a destination device indicated by the PREQ is accessible and that a target only flag field of a corresponding target flags field indicates a first value (e.g., 0). For example, the receiving device may determine that path information of the destination device indicated by the first target address field 1128 is accessible and that a target only flag field of the first target flags field 1126 has a first value (e.g., 0) indicating that an intermediate device with a path to the destination device is to send a PREP to the originator device.

The receiving device, in response to determining that the path information is accessible and determining that the target only flag field has the first value, may generate a PREP, may set the target only flag field of the PREQ to a second value (e.g., 1), may send the PREP to the originator device via the a device that sent the PREQ to the receiving device, and may forward the PREQ. The PREP may indicate the value of the hop count field 1108, the value of the metric field 1122, or both.

The receiving device, in response to determining that the path information is accessible and determining that the receiving device is a destination device, may generate a PREP and may send the PREP to the originator device via the device that sent the PREQ to the receiving device.

Each device that receives the PREP may have access to the path information to the originator device. For example, the receiving device may have created or updated the path information to the originator device in response to receiving the PREQ, as described herein. The receiving device may forward the PREP to a device that sent the PREQ to the receiving device based on the identifier of the sending device in the path information.

The receiving device may create or update path information to a destination device based on the PREP. For example, the receiving device may create the path information to the destination device in response to determining that another PREP with the same destination device has not been previously received. The path information may indicate a value of a metric field, a value of a target group device address field, a value of a target HWMP sequence number field, a value of a hop count field, a value of a target external address field, a value of an originator group device address field, a value of an originator HWMP sequence number field of the PREP, an identifier (e.g., a MAC address) of a device that sent the PREP to the receiving device, an identifier of a device that sent the PREQ to the receiving device, or a combination thereof

In a particular implementation, the receiving device may associate with the device that sent the PREP to the receiving device, the device that sent the PREQ to the receiving device, or both, in response to creating or updating path information to the destination device. For example, the receiving device may establish a pairwise key, as described with reference to FIG. 1, with the device that sent the PREP to the receiving device and/or the device that sent the PREQ to the receiving device,.

As another example, the receiving device may update the path information of the destination device in response to determining that the value of the target HWMP sequence number field of the PREP is greater than a value of a target HWMP sequence number field indicated in the path information. Additionally or alternatively, the receiving device may update the path information of the destination device in response to determining that the value of the metric field of the PREP is greater (or less) than the value of the metric field indicated in the path information.

The receiving may update (e.g., decrement by 1) a value of an element TTL field of the PREP. In some implementations, the receiving device may forward the PREP in response to creating or updating the path information of the destination device. Additionally, the receiving device may forward the PREP in response to determining that a value of a lifetime field of the PREP and a value of an element TTL field of the PREP are unexpired.

In some implementation, the receiving device may not forward and/or may discard the

PREP in response to determining that the value of the lifetime field of the PREP is expired. Additionally or alternatively, the receiving device may not forward and/or may discard the PREP in response to determining that the value of the element TTL field of the PREP is expired.

The format 1100 may enable a device to exchange information regarding one or more targets and an originator device of a PREQ. The device may establish a path from the originator device to the one or more destination devices based on the PREQ. The originator device may establish a path between the originator device and fewer than all other devices of the data link group and may thus reduce a communication overhead corresponding to exchanging data using the data link group.

Referring to FIG. 12, an illustrative example of a format of a path reply (PREP) is shown and generally designated 1200. In a particular implementation, the PREP may correspond to the PREP 166, the PREP 168 of FIG. 1, or both.

The format 1200 includes a PREP element format 1232 and a flags field format 1234.

The PREP element format 1232 may include an element identifier (ID) field 1202, a length field 1204, a flags field 1206, a hop count field 1208, an element time-to-live (TTL) field 1210, a target group device address field 1212, a target HWMP sequence number field 1214, a target external address field 1216, a lifetime field 1218, a metric field 1220, an originator group device address field 1222, an originator HWMP sequence number field 1224, or a combination. Each of the element ID field 1202, the length field 1204, the flags field 1206, the hop count field 1208, and the element TTL field 1210 may have a first particular length (e.g., 1 octet), as an illustrative, non-limiting example. Each of the target HWMP sequence number field 1214, the lifetime field 1218, the metric field 1220, and the originator HWMP sequence number field 1224 may have a second particular length (e.g., 4 octets), as an illustrative, non-limiting example. Each of the target group device address field 1212, the target external address field 1216, and the originator group device address field 1222 may have a third particular length (e.g., 6 octets), as an illustrative, non-limiting example. In some implementations, the target external address field 1216 may have a length of zero octets, as an illustrative, non-limiting example. For example, the PREP element format 1232 may not include the target external address field 1216.

The flags field format 1234 may include a reserved field 1226, an address extension (AE) field 1228, a reserved field 1230, or a combination thereof Each of the AE field 1228 and the reserved field 1230 may have a first particular length (e.g., 1 bit), as an illustrative, non-limiting example. The reserved field 1226 may have a second particular length (e.g., 6 bits), as an illustrative, non-limiting example. The flags field format 1234 may correspond to the flags field 1206.

During operation, a first device of a data link group may generate a PREP, as described with reference to FIGS. 1, 2, 4, and 5. For example, the first device may generate the PREP in response to receiving the PREQ 164 of FIG. 1, as described with reference to FIGS. 1, 2, 4, and 5. The first device may update the received PREQ 164 and may generate the PREP based on the updated PREQ. For example, the first device may update a value of the hop count field 1108, the metric field 1122, or both, as described with reference to FIG. 11.

The first device may set the target group device address field 1212 to an address, such as a MAC address, of a destination device of the data link group. Additionally, the first device may set the target HWMP sequence number field 1214 to a HWMP sequence number field of the destination device. The first device may set the target group device address field 1212 based on a target address field, such as the first target address field 1128 or the nth target address field 1134 of FIG. 11, of the PREQ 164. Additionally, the first device may set the target HWMP sequence number field 1214 based on a target HWMP sequence number field, such as the first target HWMP sequence number field 1130 or the nth target HWMP sequence number field 1136 of FIG. 11, of the PREQ 164. In some implementations, the destination device may generate a particular target HWMP sequence number and may set the target HWMP sequence number field 1214 based on the particular target HWMP sequence number.

The first device may set the hop count field 1108 based on the hop count field 1108 of FIG. 11 of the PREQ 164. The first device may set the metric field 1220 based on the metric field 1122 of FIG. 11 of the PREQ 164.

The destination device may initialize the lifetime field 1218, the element TTL field 1210, or both, to particular values. Each device on a path to an originator device may discard the PREP in response to determining that the value of the lifetime field 1218 is expired, that the value of the element TTL field 1210 is expired, or both. Alternatively, each device on the path may update the element TTL field 1210 in response to determining that the values of the lifetime field 1218 and of the element TTL field 1210 are unexpired and may forward the PREP.

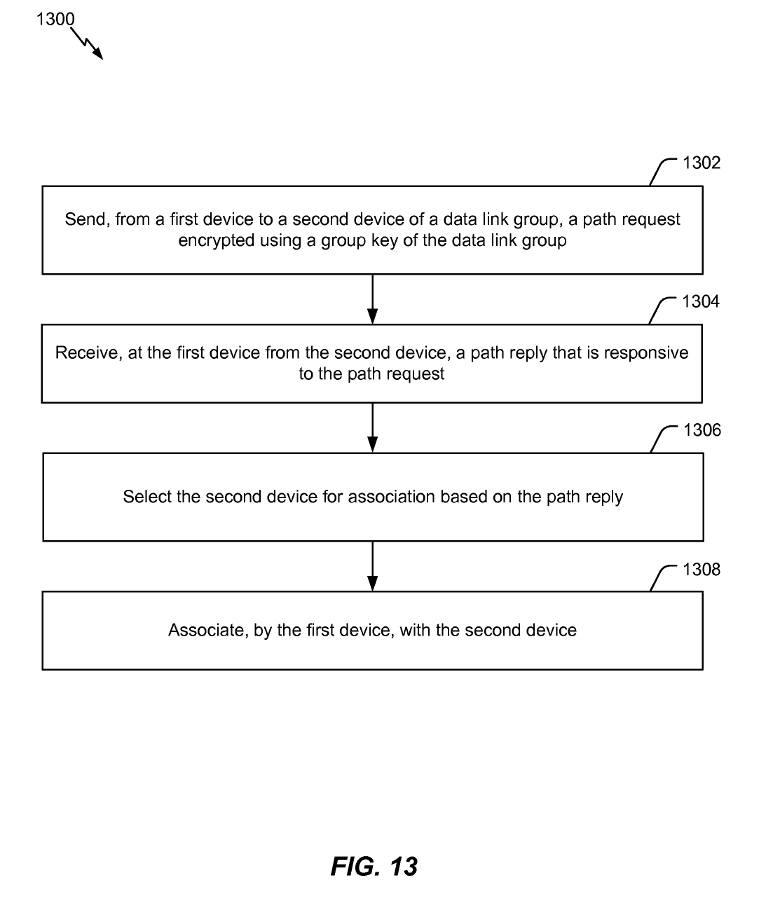

Referring to FIG. 13, an illustrative method of selectively associating is shown and generally designated 1300. The method 1300 may be performed by a device, such as the one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8. For example, in some implementations, the method 1300 may be performed by the group networking module 102 of one or more of the devices 110, 120, 130, 140 of FIG. 1.

The method 1300 includes sending, from a first device to a second device of a data link group, a path request encrypted using a group key of the data link group, at 1302. For example, the first device may include a transmitter (e.g., the transmitter 106 of FIG. 1) that is configured to send the path request from the first device to the second device. In some implementations, the first device may encrypt the path request using the group key prior to transmitting the path request. The path request may include or correspond to the PREQ 164 of FIG. 1. The path request may include data that indicates a particular device (such as a provider device) of the data link group. The path request may be configured to enable the first device to identify a shortest path to the particular device of the data link group. The particular device may be configured to provide a service to other devices of the data link group. For example, the service may include at least one of audio streaming, video streaming, a data service, another service, or a combination thereof, as illustrative, non-limiting examples.

The method 1300 also includes receiving, at the first device from the second device, a path reply that is responsive to the path request, at 1304. For example, the first device may include a receiver that is configured to receive the path reply from the second device. In some implementations, the path reply may be encrypted using the group key, and the first device may decrypt the path reply using the group key in response to receiving the path reply. The path reply may include or correspond to the PREP 166, 168 of FIG. 1. The path reply received by the first device may be generated by the particular device responsive to the particular device receiving the path request forwarded from the second device. The path reply may include data that indicates a particular hop count from the first device via the second device to the particular device of the data link group, a metric parameter corresponding to first path from the first device to the particular device, or both. The metric parameter may indicate a number of lost packets, a bandwidth, a latency, a load, a reliability measure, or a combination thereof.

The method 1300 further includes selecting the second device for association based on the path reply, at 1306. For example, the second device may be selected for association in response to determining that the first hop count has a lower value than the second hop count. Additionally or alternatively, the second device may be selected for association in response to comparing the first metric parameter value and the second metric parameter value.

The method 1300 includes associating, by the first device, with the second device, at 1308. Associating the first device and the second device may establish a pairwise key, such as the pairwise key 122 of FIG. 1. In some implementations, the pairwise key may enable secure wireless communication of unicast data message between the first device and the second device.

In some implementations, the method 1300 may include, prior to sending the path request, joining, by the first device, to the data link group. To join the data link group, the first device may perform a group authentication, such as a single group authentication with a device of the data link group to receive authorization to join the data link group. Joining the data link group may include receiving, at the first device, the group key from the second device. Each device of the data link group may include a group key, such as the same group key. In some implementations, the group key enables secure wireless communication of group addressed data messages corresponding to the data link group. For example, after joining the first device to the data link group, the first device may transmit group addressed traffic (generated using the group key) to devices of the data link group. In some implementations, joining the data link group may include associating the first device with another device of the data link group. Referring to FIG. 1, the first device 110 may associate with the third device 130.

In some implementations, the data link group (that includes the first device) may include an infrastructure-less peer-to-peer network, such as the wireless network 101 of FIG. 1. For example, the data link group may include multiple devices of a neighborhood-aware network (NAN) which enables data connectivity amongst the multiple devices. In some implementations, the data link group may have a multi-hop topology. In other implementations, the data link group may have a single-hop topology.

In some implementations, the method 1300 may include receiving, during a discovery window, a discovery message at the first device from a device of the data link group. For example, the device may include the third device 130 of FIG. 1 and the discovery message may correspond to the discovery message 205 of FIG. 2. The discovery message may include information that indicates availability of a service corresponding to the data link group. For example, the service may be provided by the device that sent the discovery message or by another device of the data link group. In response to receiving the discovery message, the first device may send an authentication message to the device. For example, referring to FIGS. 2, the first device 110 may send the authentication message 207 to the third device 130 in response to receiving the discovery message 205 from the third device 130. In some implementations, the discovery window may include or correspond to a neighborhood-aware network (NAN) discovery window.

In some implementations, sending the path request may include broadcasting the path request to one or more devices of the data link group within communication range of the first device. The path request may include data that indicates a particular device, such as the provider device, of the data link group. The path request (encrypted using the group key) may be broadcast as a group addressed message to devices of the data link group. For example, path requests may be sent to a plurality of devices included in the data link group. Each path request may include first data that identifies the particular device configured to provide the service that corresponds to the data link group. To illustrate, the method 1300 may include sending, from the first device to a third device of the data link group, a second path request generated (e.g., encoded) using the group key.

In some implementations, the method 1300 may include receiving a plurality of path replies from the plurality of devices. Each of the plurality of path replies may include second data that indicates a particular hop count to the particular device, a particular metric parameter (e.g., a value of the particular metric parameter), or both. The first device may select the second device based on the plurality of path replies. To illustrate, the first device may receive a second path reply (from a third device) that is responsive to the second path request. The first device may select the second device for association based on the second path reply.

In some implementations, the path reply may include first data that indicates one or more security protocols supported by the second device, a first value generated by the second device to enable establishment of a pairwise key between the first device and the second device, or a combination thereof Additionally or alternatively, the path reply may include second data that indicates physical (PHY) layer capabilities, MAC layer capabilities, or both, of one or more devices along a path from the first device to the particular device (e.g., the provider device) that corresponds to the path request. In some implementations, the method 1300 may include sending an authentication response from the first device to the second device in response to selecting the second device. For example, the first device may generate and/or send the authentication response based on the first data and/or the second data included in the path reply.

In some implementations, the method 1300 may include detecting an authentication request received from the second device at the first device. For example, the authentication request may include or correspond to the authentication request 174 of FIG. 1. The authentication request may indicate a plurality of security protocols supported by the second device. In a particular implementation, the authentication request is included in the path reply.

The first device may send an authentication response, such as the authentication response 172 of FIG. 1, to the second device in response to selecting the second device. Prior to sending the authentication response, the first device may select a security protocol, such as the security protocol 286 of FIG. 2, of the plurality of security protocols. The selected security protocol may be supported by the first device and the authentication response may include security selection data that indicates the selected security protocol.

In a particular implementation, the authentication request may include a first value (generated by the second device) and the authentication reply may include a second value (generated by the first device). For example, each of the first value and the second value may be a distinct nonce value. The pairwise key may be established based on a first value and a second value. After sending the authentication response to the second device, the first device may receive an association request from the second device. For example, the association request may include or correspond to the association request 288 of FIG. 2 or 3. The association request may include first information that indicates a first association identifier, such as the first association ID (A_IDa) 292. The first device may send an association response, such as the association response 294 of FIG. 2 or 3, the second device responsive to the association request. The association response may include second information that indicates a second association identifier, such as the second association ID (A_IDb) 296.

In some implementations, the method 1300 may include, after joining the first device to the data link group, monitoring a group communication channel of the data link group during a group paging window of the data link group. For example, after associating the first device with the second device, the first device may receive a traffic indication message (e.g., the TIM 298 of FIG. 2) from the second device during the group paging window. The group communication channel may correspond to the group communication channel 736 of FIG. 7. The first device may monitor the group communication channel during a group data window in response to determining that the traffic indication message indicates that the second device has data to send to the first device. For example, the data may include or correspond to the data 299 of FIG. 2. The first device may receive the data from the second device during the group data window. In a particular implementation, the data is encrypted based on the pairwise key, such as the pairwise key 122 of FIG. 1.

The method 1300 may enable service discovery in a network having a single-hop topology or a multi-hip topology. For example, the first device may discover that a service is available via the data link group. The first device may perform path discovery corresponding to a destination device (e.g., a provider device of the service) to identify another device of the data link group for association. By performing the path discovery, the first device may select and associate with another device based on a path to the destination device that is determined to be efficient. Associating with the other device and communicating messages to the destination device via the other device may reduce a number of messages exchanged between devices of the data link group.

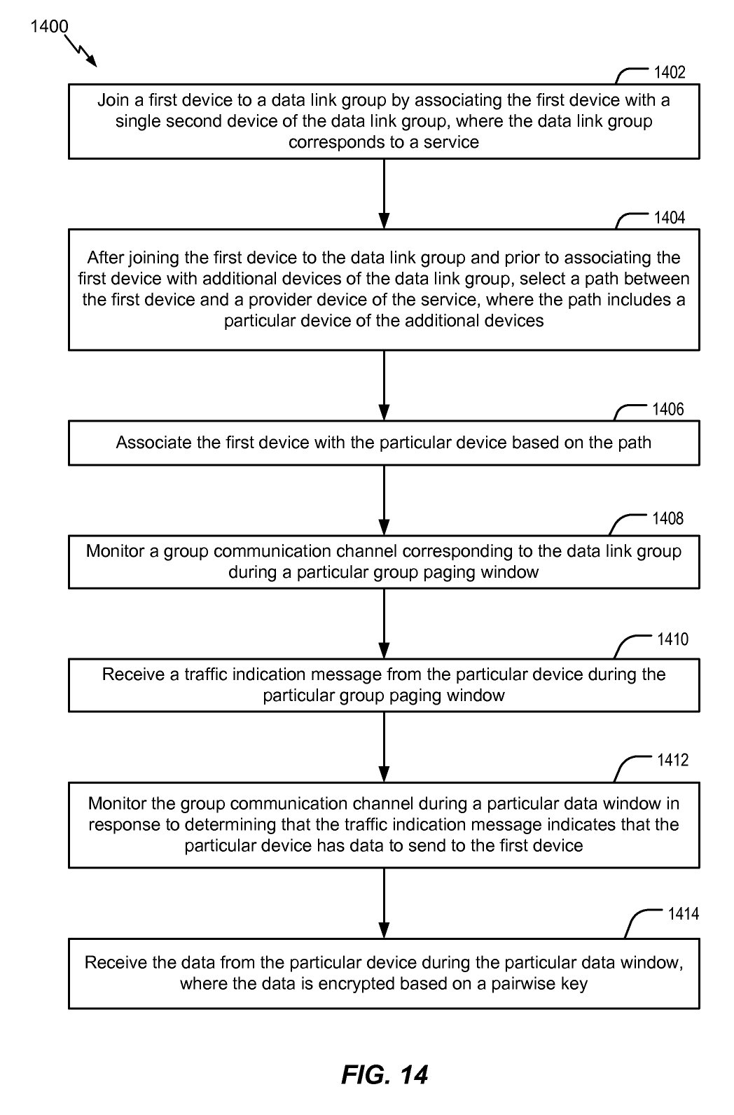

Referring to FIG. 14, an illustrative method of selective association is shown and generally designated 1400. The method 1400 may be performed by a device, such as the one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8. For example, in some implementations, the method 1400 may be performed by the group networking module 102 of one or more of the devices 110, 120, 130, 140 of FIG. 1.

The method 1400 includes joining a first device to a data link group by associating the first device with a single second device of the data link group, at 1402. The data link group may correspond to a service, such as a service that corresponds to the application (A6) 712 of FIG. 7. Referring to FIG. 1, the first device 110 may join the data link group of FIG. 1 by associating the first device 110 with a single second device, such as the third device 130, of the data link group.

The method 1400 also includes selecting a path between the first device and a provider device of the service after joining the first device to the data link group and prior to associating the first device with additional devices of the data link group, at 1404. For example, the first device may wait to associate with another device until after the first device selects the path. The path may include a particular device of the additional devices. Referring to FIG. 1, the first device 110 of FIG. 1 may select a path between the first device 110 and the fourth device 140 after joining the first device 110 to the data link group and prior to associating the first device 110 with additional devices, such as the second device 120 and/or the third device 130, of the data link group. In some implementations, the path may include the second device 120. In other implementations, the particular device may be the provider device of the service.

The method 1400 further includes associating the first device with the particular device based on the path, at 1406. Referring to FIG. 1, the first device 110 may associate with the second device 120 based on the path. After associating the first device with the particular device, each of the first device and the particular device may include the pairwise key 122 of FIG. 1.

The method 1400 may also include monitoring a group communication channel corresponding to the data link group during a particular group paging window, at 1408. For example, the first device 110 of FIG. 1 may monitor the group communication channel 736 of the data link group during a group paging window, such as the first group paging window 802 of FIG. 8.

The method 1400 may further include receiving a traffic indication message from the particular device during the particular group paging window, at 1410. Referring to FIG. 2, the first device 110 may receive the TIM 298 from the second device 120 during the group paging window.

The method 1400 may also include monitoring the group communication channel during a particular group data window in response to determining that the traffic indication message indicates that the particular device has data to send to the first device, at 1412. Referring to FIG. 2, the first device 110 may monitor the group communication channel 736 during a group data window, such as the group data window 803 of FIG. 8, in response to determining that the TIM 298 indicates that the second device 120 has data, such as the data 299 of FIG. 2, to send to the first device 110.

The method 1400 may further include receiving the data from the particular device during the particular group data window, at 1414. The data may be encrypted based on a pairwise key, such as the pairwise key 122 of FIG. 1. Referring to FIG. 2, the first device 110 may receive the data 299 from the second device 120 during the group data window.

The method 1400 may enable a first device to join a data link group by associating with a single second device of the data link group and, after joining the data link group and prior to associating with additional devices of the data link group, to select a path to a provider device. The first device may associate with a particular device that corresponds to the path. The first device may thus reduce communication overhead related to participating in a data link group by not associating with all available devices of the data link group that are within a communication range of the first device.

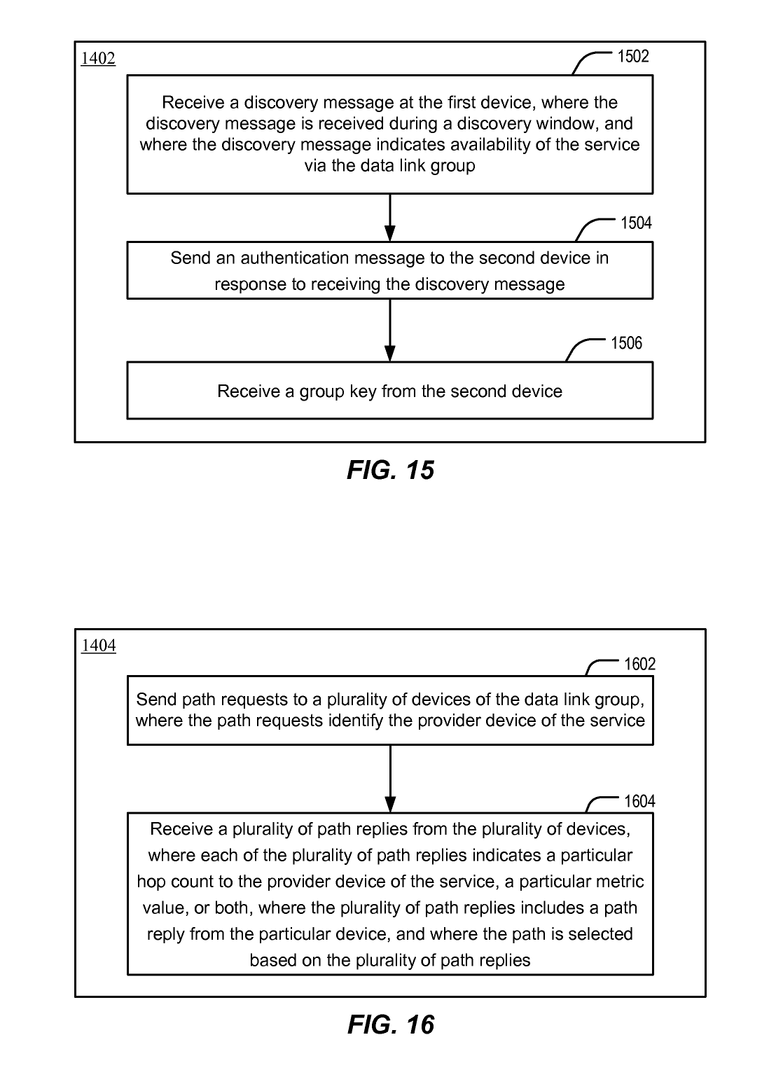

Referring to FIG. 15, an illustrative method of joining a data link group is shown and generally designated 1402. The method 1402 of FIG. 15 may correspond to 1402 of FIG. 14. The method 1402 may be performed by a device, such as the one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8. For example, in some implementations, the method 1402 may be performed by the group networking module 102 of one or more of the devices 110, 120, 130, 140 of FIG. 1.

The method 1402 may include receiving a discovery message at the first device, at 1502. The discovery message may be received during discovery window, such as a neighborhood-aware network (NAN) discovery window. The discovery message may indicate availability of the service via the data link group. Referring to FIG. 2, the first device 110 may receive the discovery message 205 from the third device 130 during a discovery window, such as the first discovery window 718 of FIG. 7.

The method 1402 may also include sending an authentication message to the second device in response to receiving the discovery message, at 1504, and may include receiving a group key from the second device, at 1506. Referring to FIG. 2, the first device 110 may send the authentication message 207 to the third device 130 in response to receiving the discovery message 205. The group key may include the group key 124 of FIG. 1.

The method 1402 may enable the first device to join the data link group by associating with a single second device of the data link group. For example, the first device may join the data link group by sending an authentication message to the second device in response to receiving a discovery message from the second device and by receiving the group key of the data link group from the second device. The first device may thus reduce communication overhead corresponding to joining the data link group by associating with a single device of the data link group.

Referring to FIG. 16, an illustrative method of operating a device of a data link group is shown and generally designated 1404. The method 1404 may correspond to 1404 of FIG. 14. The method 1404 may be performed by a device, such as the one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8. For example, in some implementations, the method 1404 may be performed by the group networking module 102 of one or more of the devices 110, 120, 130, 140 of FIG. 1.

The method 1404 includes sending path requests to a plurality of devices associated with the data link group, at 1602. The path requests may identify the provider device of the service. Referring to FIG. 1, the first device 110 may, after joining the data link group, broadcast the PREQ 164 to the third device 130 and to the second device 120. The PREQ 164 may identify the provider device, such as the fourth device 140.

The method 1404 also includes receiving a plurality of path replies from the plurality of devices, at 1604. Each of the plurality of path replies may indicate a particular hop count to the provider device of the service, a particular metric parameter, or both. The plurality of path replies may include a path reply from the particular device (such as the second device 120). The path may be selected based on the plurality of path replies. Referring to FIG. 1, the first device 110 may receive the PREP 166 from the third device 130 and the PREP 168 from the second device 120. The PREP 166 may indicate the first hop count 176, the first metric parameter value 178, or both. The PREP 168 may indicate the second hop count 182, the second metric parameter value 184, or both. The path may be selected based on the PREP 166 and the PREP 168.

The method 1404 may enable a first device to select a path to the provider device. The path may include the particular device. The first device may join the data link group by associating with a single device to acquire the group key. The first device may wait to associate with additional devices of the data link group until after selecting the path. The first device may associate with the particular device based on the selected path. The first device may thus reduce communication overhead related to participating in data link group by associating with the particular device corresponding to the selected path and refraining from associating with additional devices of the data link group that are within communication range of the first device.

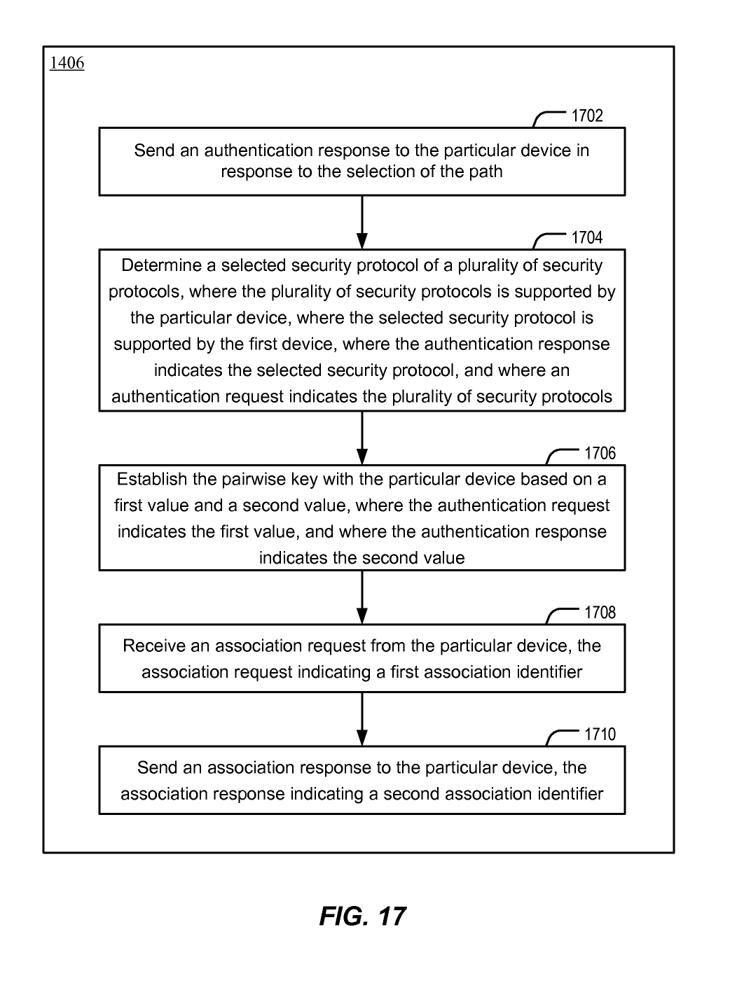

Referring to FIG. 17, an illustrative method of data link group association is shown and generally designated 1406. The method 1406 may correspond to 1406 of FIG. 14. The method 1406 may be performed by a device, such as the one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8. For example, in some implementations, the method 1406 may be performed by the group networking module 102 of one or more of the devices 110, 120, 130, 140 of FIG. 1.

The method 1406 may include sending an authentication response to the particular device in response to the selection of the path, at 1702. Referring to FIGS. 1-3, the first device 110 may send the authentication response 172 to the second device 120 in response to the selection of the path. For example, the first device 110 ay send the authentication response 172 in response to selection of an unassociated device that is available for associating with the first device 110.

The method 1406 may also include determining a selected security protocol of a plurality of security protocols, at 1704. The plurality of security protocols may be supported by the particular device and supported by the first device. The authentication response may indicate the selected security protocol. An authentication request may indicate the plurality of security protocols. Referring to FIG. 2, the first device 110 may determine the security protocol 286 of a plurality of security protocols supported by the second device 120. The authentication request 174 may indicate the plurality of security protocols and the authentication response 172 may indicate the security protocol 286.

The method 1406 may further include establishing a pairwise key with the particular device based on a first value and a second value, at 1706. The authentication request may indicate the first value. The authentication response may indicate the second value. Referring to FIGS. 2 and 3, the first device 110 may establish the pairwise key 122 with the second device 120 based on a first value (indicated by the authentication request 174) and a second value (indicated by the authentication response 172).

The method 1406 may also include receiving an association request from the particular device, at 1708. The association request may indicate a first association identifier. For example, the first device 110 may receive the association request 288 from the second device 120, as described with reference to FIG. 2. The association request 288 may indicate the first association ID (A_IDa) 292.

The method 1406 may further include sending an association response to the particular device, at 1710. The association response may indicate a second association identifier. Referring to FIG. 2, the first device 110 may send the association response 294 that indicates the second association ID (A_IDb) 296 to the second device 120.

The method 1406 may enable a first device to associate with the particular device based on a selected path via the particular device to a provider device. The first device may thus reduce communication overhead related to participating in a data link group by associating with the particular device on the selected path and waiting to associate with additional devices of the data link group.

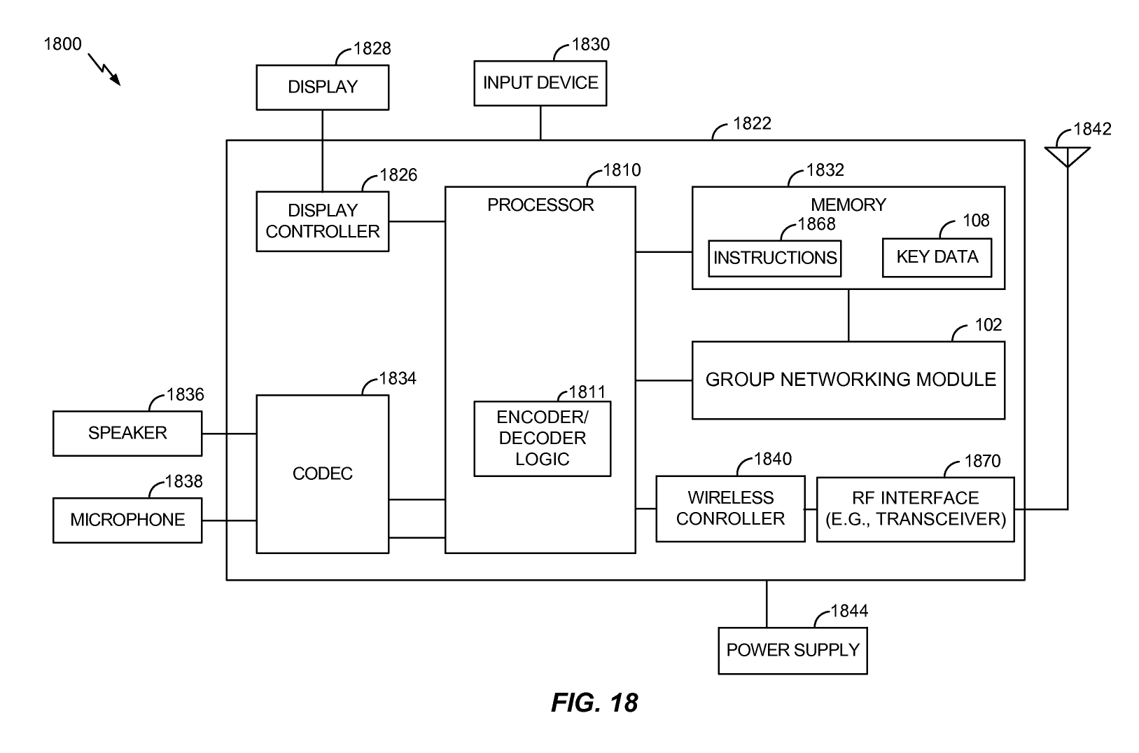

In particular aspects, the methods of FIGS. 13-17 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof As an example, one or more of the methods of FIGS. 13-17, individually or in combination, may be performed by a processor that executes instructions, as described with respect to FIG. 18. To illustrate, a portion of one of the methods FIGS. 13-17 may be combined with a second portion of one of the methods of FIGS. 13-17. Additionally, one or more steps described with reference to the FIGS. 13-17, may be optional, may be performed at least partially concurrently, and/or may be performed in a different order than shown or described.

Referring to FIG. 18, a block diagram of an illustrative example of a device is depicted and generally designated 1800. In some implementations, the device 1800 may include an electronic device, such as a wireless communication device. The device 1800 may correspond to at least one of the devices 110, 120, 130, 140 of FIG. 1, the devices the devices 430-448 of FIG. 4, the devices of the data link group of FIG. 6, and/or the devices of the data link group 703, 704, 706 of FIG. 7, one of the first device (Device1), the second device (Device2), the third device (Device3), or the fourth device (Device4) of FIG. 8.

The device 1800 includes a processor 1810, such as a digital signal processor (DSP) or a central processing unit (CPU), coupled to a memory 1832. The memory 1832 may include instructions 1868 and the key data 108. The key data 108 may include one or more keys, such as the group key 124 and/or the pairwise key 122 of FIG. 1. The processor 1810 may include encoder/decoder logic 1811. The encoder/decoder logic 1811 may be configured to encode and/or decode data, such as messages received by the device 1800 and/or messages to be transmitted by the device 1800. The processor 1810 may be coupled to, or may include, the group networking module 102. The group networking module 102 may be configured to operate according to the method 1300 of FIG. 13, the method 1400 of FIG. 14, the method 1402 of FIG. 15, the method 1404 of FIG. 16, the method 1406 of FIG. 17, or a combination thereof Although the encoder/decoder logic 1811 is illustrated as being separate from the group networking module 102, in other implementations, the encoder/decoder logic 1811 may be included in the group networking module 102.

The group networking module 102 may be configured to generate a discovery message (e.g., the discovery message 205 of FIG. 2), may receive a message (e.g., the discovery message 205 of FIG. 2), may join a data link group , may associate with a particular device of the data link group to join data link group, or a combination thereof Additionally or alternatively, the group networking module 102 be configured to generate or receive a PREQ, such as the PREQ 164 of FIG. 1, may initiate transmission (e.g., forwarding) of the PREQ, may generate and/or receive a PREP, such as the PREP 166 or 168 of FIG. 1, or a combination thereof Further the group networking module 102 may be configured to, in response to receiving the PREQ (e.g., the PREQ 164), initiate transmission of the PREP, may select a particular device to a provider device in response to receiving a PREP, may associate with the particular device, or a combination thereof.

In a particular implementation, the group networking module 102 may be implemented on-chip, such as via the processor 1810. For example, the memory 1832 may be a computer-readable storage device (e.g., a non-transitory computer-readable medium) storing computer-executable instructions 1868 that are executable by the processor 1810 to cause the processor 1810 to perform operations of the group networking module 102. For example, the processor 1810 may initiating wireless transmission, from a first device to a second device of a data link group, of a path request encrypted using a group key of the data link group. The operations further include selecting the second device for association based on a path reply received from the second device. The path reply is responsive to the path request. The operations also include associating the first device with the second device.

FIG. 18 also shows a display controller 1826 that is coupled to the processor 1810 and to a display 1828. A coder/decoder (CODEC) 1834 can also be coupled to the processor 1810. A speaker 1836 and a microphone 1838 can be coupled to the CODEC 1834.

FIG. 18 also indicates that a wireless controller 1840 can be coupled to the processor 1810 and, via a radio frequency (RF) interface 1870, to an antenna 1842. The RF interface 1870 (e.g., a transceiver) may include the receiver 104, the transmitter 106, or both, of FIG. 1. In some implementations, the processor 1810, the group networking module 102, the display controller 1826, the memory 1832, the CODEC 1834, and the wireless controller 1840 are included in a system-in-package or system-on-chip device 1822. Additionally or alternatively, an input device 1830 and a power supply 1844 are coupled to the system-on-chip device 1822. Moreover, in other implementations, as illustrated in FIG. 18, the display 1828, the input device 1830, the speaker 1836, the microphone 1838, the antenna 1842, and the power supply 1844 are external to the system-on-chip device 1822. However, each of the display 1828, the input device 1830, the speaker 1836, the microphone 1838, the antenna 1842, and the power supply 1844 can be coupled to a component of the system-on-chip device 1822, such as an interface or a controller.

In conjunction with one or more of the described aspects of FIGS. 1-18, an apparatus is disclosed that may include means for sending, to a device of a data link group, a path request encrypted using a group key of the data link group. The means for sending the path request may include or correspond to the group networking module 102, the transmitter 106 of FIG. 1, the wireless controller 1840, the RF interface 1870, the antenna 1842, the processor 1810 programmed to execute the instructions 1868 of FIG. 18, a transceiver (e.g., a transmitter and/or a receiver), one or more other structures, components, and/or circuits configured to send the path request, or any combination thereof.

The apparatus may also include means for receiving, from the device, a path reply that is responsive to the path request. The means for receiving the path reply may include or correspond to the group networking module 102, the receiver 104 of FIG. 1, the wireless controller 1840, the RF interface 1870, the antenna 1842, the processor 1810 programmed to execute the instructions 1868 of FIG. 18, a transceiver, one or more other structures, components, and/or circuits configured to receive the path reply, or any combination thereof.

The apparatus may also include means for selecting the device for association based on the path reply. The means for selecting include or correspond to group networking module 102 of FIG. 1, the processor 1810 programmed to execute the instructions 1868 of FIG. 18, one or more other structures, components, and/or circuits configured to select the device, or any combination thereof.

The apparatus may also include means for associating with the device. The means for associating may include or correspond to the group networking module 102, the receiver 104, the transmitter 106 of FIG. 1, the wireless controller 1840, the RF interface 1870, the antenna 1842, the processor 1810 programmed to execute the instructions 1868 of FIG. 18, a transceiver, one or more other structures, components, and/or circuits configured to associated with the device, or any combination thereof.

One or more of the disclosed aspects may be implemented in a system or an apparatus, such as the device 1800, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 1800 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, any other device that includes a processor or that stores or retrieves data or computer instructions, or a combination thereof. As another illustrative, non-limiting example, the system or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

Although one or more of FIGS. 1-18 may illustrate systems, apparatuses, and/or methods according to the teachings of the disclosure, the disclosure is not limited to these illustrated systems, apparatuses, and/or methods. One or more functions or components of any of FIGS. 1-18 as illustrated or described herein may be combined with one or more other portions of another of FIGS. 1-18. Accordingly, no single aspect described herein should be construed as limiting and aspects of the disclosure may be suitably combined without departing from the teachings of the disclosure.

Those of skill would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. For example, a storage medium may be coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal.

The previous description is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method of selectively associating, the method comprising:
sending, from a first device to a second device of a data link group, a path request encrypted using a group key of the data link group;
receiving, at the first device from the second device, a path reply that is responsive to the path request;
selecting the second device for association based on the path reply; and
associating, by the first device, with the second device.

2. The method of claim 1, further comprising, prior to sending the path request, joining, by the first device, the data link group, wherein joining the data link group comprises receiving, at the first device, the group key from the second device, and wherein each device of the data link group includes the same group key.

3. The method of claim 1, wherein associating with the second device includes establishing a pairwise key, wherein the group key enables secure wireless communication of group addressed data messages corresponding to the data link group, and wherein the pairwise key enables secure wireless communication of unicast data message between the first device and the second device.

4. The method of claim 1, wherein sending the path request includes broadcasting the path request to one or more devices of the data link group within communication range of the first device.

5. The method of claim 4, wherein the path request is broadcast as a group addressed message.

6. The method of claim 1, wherein the path request includes data that indicates a provider device of the data link group.

7. The method of claim 6, wherein the path request is configured to enable the first device to identify a shortest path to the provider device of the data link group.

8. The method of claim 6, wherein the path reply received by the first device is generated by the provider device responsive to the provider device receiving the path request via the second device, and wherein the provider device is configured to provide a service to other devices of the data link group.

9. The method of claim 1, wherein the path reply includes data that indicates one or more security protocols supported by the second device, a first value generated by the second device to enable establishment of a pairwise key between the first device and the second device, or a combination thereof, and further comprising sending an authentication response from the first device to the second device in response to selecting the second device.

10. The method of claim 1, wherein the path reply includes data that indicates physical (PHY) layer capabilities, media access control (MAC) layer capabilities, or both, of one or more devices along a path from the first device to a provider device of the data link group that corresponds to the path request.

11. The method of claim 1, wherein the path reply includes data that indicates a hop count from the first device via the second device to a provider device of the data link group, a metric parameter corresponding to a first path from the first device to the provider device, or both.

12. The method of claim 11, wherein the metric parameter indicates a number of lost packets, a bandwidth, a latency, a load, a reliability measure, or a combination thereof.

13. The method of claim 1, further comprising:
sending, from the first device to a third device of the data link group, a second path request encrypted using the group key; and
receiving, at the first device from the third device, a second path reply that is responsive to the second path request,
wherein the second device is selected for association further based on the second path reply.

14. The method of claim 13, further comprising:
determining a first hop count indicated by first data included in the path reply; and
determining a second hop count indicated by second data included in the second path reply, wherein the second device is selected for association in response to determining that the first hop count has a lower value than the second hop count.

15. The method of claim 13, further comprising:
determining a first metric parameter value indicated by first data included in the path reply; and
determining a second metric parameter value indicated by second data included in the second path reply, wherein the second device is selected for association in response to comparing the first metric parameter value and the second metric parameter value.

16. The method of claim 1, further comprising, after joining the first device to the data link group, monitoring a group communication channel of the data link group during a group paging window of the data link group.

17. The method of claim 16, further comprising, after associating the first device with the second device:
receiving a traffic indication message from the second device during the group paging window; and
monitoring the group communication channel during a group data window in response to determining that the traffic indication message indicates that the second device has data to send to the first device; and
receiving the data from the second device during the group data window, wherein the data is encrypted based on a pairwise key.

18. A device comprising:
a memory; and
a processor configured to:
initiate wireless transmission of a path request, encrypted using a group key of a data link group, from a first device to a second device of the data link group;
select the second device for association based on a path reply received from the second device, the path reply responsive to the path request; and
associate the first device with the second device.

19. The device of claim 18, further comprising:
a transmitter configured to send the path request from the first device to the second device, wherein the path request includes data that indicates a provider device configured to provide a service corresponding to the data link group; and
a receiver configured to receive the path reply from the second device, wherein the path reply is encrypted using the group key.

20. An apparatus comprising:
means for sending, to a device of a data link group, a path request encrypted using a group key of the data link group;
means for receiving, from the device, a path reply that is responsive to the path request; and
means for selecting the device for association based on the path reply; and
means for associating with the device.

21. The apparatus of claim 20, wherein the data link group comprises an infrastructure-less peer-to-peer network.

22. The apparatus of claim 20, wherein the data link group includes multiple devices of a neighborhood-aware network (NAN).

23. A computer-readable storage device storing instructions that, when executed by a processor, cause the processor to perform operations comprising:
initiating wireless transmission, from a first device to a second device of a data link group, of a path request encrypted using a group key of the data link group;
selecting the second device for association based on a path reply received from the second device, the path reply responsive to the path request; and
associating the first device with the second device.

24. The computer-readable storage device of claim 23, wherein the operations further comprise
sending path requests to a plurality of devices included in the data link group, each of the path requests including first data that identifies a provider device configured to provide a service that corresponds to the data link group; and
receiving a plurality of path replies from the plurality of devices, each of the plurality of path replies including second data that indicates a hop count to the provider device, a metric parameter, or both, wherein the second device is selected based on the plurality of path replies.

25. The computer-readable storage device of claim 23, wherein the operations further comprise:
receiving, during a discovery window, a discovery message at the first device from a third device of the data link group, the discovery message includes information that indicates availability of a service corresponding to the data link group; and
sending an authentication message to the third device in response to receiving the discovery message.

26. The computer-readable storage device of claim 23, wherein the operations further comprise detecting an authentication request received from the second device at the first device, the authentication request included in the path reply.

27. The computer-readable storage device of claim 23, wherein the operations further comprise detecting an authentication request received from the second device at the first device, and wherein the instructions that cause the processor to associate the first device with the second device further cause the processor to perform initiating sending an authentication response to the second device in response to selecting the second device.

28. The computer-readable storage device of claim 27, wherein the authentication request indicates a plurality of security protocols supported by the second device, wherein the operations further comprise determining a selected security protocol of the plurality of security protocols, the selected security protocol supported by the first device, and wherein the authentication response includes security selection data that indicates the selected security protocol.

29. The computer-readable storage device of claim 27, wherein the operations further comprise establishing a pairwise key based on a first value and a second value, wherein the authentication request includes the first value, and wherein the authentication response includes the second value.

30. The computer-readable storage device of claim 27, wherein the operations further comprise:
after sending the authentication response to the second device, receiving an association request from the second device at the first device, the association request including first information that indicates a first association identifier; and
sending an association response from the first device to the second device, the association response including second information that indicates a second association identifier.
